(19) United States
(12) Patent Application Publication
(10) Pub. No.: US 2025/0317179 A1
(43) Pub. Date: Oct. 9, 2025

(54) MEASUREMENT AND REPORTING

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 19/088,778

(22) Filed: Mar. 24, 2025

Related U.S. Application Data
(60) Provisional application No. 63/575,517, filed on Apr. 5, 2024.

(51) Int. Cl. H04B 7/06; H04W 24/10

(52) U.S. Cl. CPC H04B 7/0626; H04B 7/0632; H04W 24/10

(57) ABSTRACT

Apparatuses and methods for measurement and reporting. A method performed by a user equipment (UE) includes receiving information about a channel state information (CSI) trigger state, the CSI trigger state including information about CSI₁, and X-1 optional CSIs, CSI₂, . . . , CSI_{X}, where X≥1 and receiving an indication indicating Y optional CSIs. When Y=0, the indication indicates none of the X-1 optional CSIs, and when Y>0, the indication indicates Y out of the X-1 optional CSIs. The method further includes determining the CSI₁ based on the information, determining, based on the indication, (i) a value of Y and (ii) when Y>0, the Y optional CSIs, and transmitting (i) the CSI₁ and (ii) when Y>0, the Y optional CSIs.

### CROSS-REFERENCE TO RELATED AND CLAIM OF PRIORITY

The present application claims priority under 35 U.S.C. § 119(e) to U.S. Provisional Patent Application No. 63/575,517 filed on Apr. 5, 2024, which is hereby incorporated by reference in its entirety.

### TECHNICAL FIELD

The present disclosure relates generally to wireless communication systems and, more specifically, the present disclosure is related to apparatuses and methods for measurement and reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to measurement and reporting.

In one embodiment, a user equipment (UE) is provided. The UE includes a transceiver configured to receive information about a channel state information (CSI) trigger state, the CSI trigger state including information about CSI₁, and X-1 optional CSIs, CSI₂, . . . , CSI_{X}, where X≥1 and receive an indication indicating Y optional CSIs. When Y=0, the indication indicates none of the X-1 optional CSIs, and when Y>0, the indication indicates Y out of the X-1 optional CSIs. The UE further includes a processor operably coupled to the transceiver. The processor is configured to determine the CSI₁ based on the information and determine, based on the indication, (i) a value of Y and (ii) when Y>0, the Y optional CSIs. The transceiver is further configured to transmit (i) the CSI₁ and (ii) when Y>0, the Y optional CSIs.

In another embodiment, a base station (BS) is provided. The BS includes a processor and a transceiver operably coupled to the processor. The transceiver is configured to transmit information about a CSI trigger state, the CSI trigger state including information about CSI₁, and X-1 optional CSIs, CSI₂, . . . , CSI_{X}, where X≥1, transmit an indication indicating Y optional CSIs, and receive (i) the CSI₁ and (ii) when Y>0, the Y optional CSIs. When Y=0, the indication indicates none of the X-1 optional CSIs, and when Y>0, the indication indicates Y out of the X-1 optional CSIs.

In yet another embodiment, a method performed by a UE is provided. The method includes receiving information about a CSI trigger state, the CSI trigger state including information about CSI₁, and X-1 optional CSIs, CSI₂, . . . , CSI_{X}, where X≥1 and receiving an indication indicating Y optional CSIs. When Y=0, the indication indicates none of the X-1 optional CSIs, and when Y>0, the indication indicates Y out of the X-1 optional CSIs. The method further includes determining the CSI₁ based on the information, determining, based on the indication, (i) a value of Y and (ii) when Y>0, the Y optional CSIs, and transmitting (i) the CSI₁ and (ii) when Y>0, the Y optional CSIs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of example radio access network (RAN) configurations according to embodiments of the present disclosure;

FIG. 11 illustrates a diagram of example functional split points/options according to embodiments of the present disclosure;

FIG. 12 illustrates an example of a fully digital transmitter structure for beamforming according to embodiments of the present disclosure;

FIG. 13 illustrates a diagram of an example antenna port layout according to embodiments of the present disclosure;

FIG. 14 illustrates a timeline of example spatial-domain (SD) units and frequency-domain (FD) units according to embodiments of the present disclosure;

FIG. 15 illustrates a diagram of example port group (PG) hypotheses according to embodiments of the present disclosure;

FIG. 16 illustrates a diagram of an example transmission configuration indication (TCI) state configuration according to embodiments of the present disclosure;

FIG. 17 illustrates a diagram of an example TCI state configuration according to embodiments of the present disclosure;

FIG. 18 illustrates a diagram of an example analog beam-based network according to embodiments of the present disclosure;

FIG. 19 illustrates examples of a UE moving on a trajectory located in co-located and distributed PGs according to embodiments of the present disclosure;

FIG. 20 illustrates a diagram of an example downlink (DL) channel state information (CSI) acquisition architecture according to embodiments of the present disclosure;

FIG. 21 illustrates a diagram of example co-located and non-co-located ports according to embodiments of the present disclosure;

FIG. 22 illustrates a diagram of example channel measurement configurations according to embodiments of the present disclosure;

FIG. 23 illustrates a diagram of an example CSI report trigger according to embodiments of the present disclosure;

FIG. 24 illustrates a diagram of an example CSI reference (resource) slot according to embodiments of the present disclosure;

FIG. 25 illustrates a diagram of an example trigger state according to embodiments of the present disclosure;

FIG. 26 illustrates a diagram of example trigger states according to embodiments of the present disclosure;

FIG. 27 illustrates a diagram of example trigger states according to embodiments of the present disclosure;

FIG. 28 illustrates a diagram of example trigger states according to embodiments of the present disclosure;

FIG. 29 illustrates a diagram of example CSI report IDs according to embodiments of the present disclosure;

FIG. 30 illustrates a diagram of an example codebook according to embodiments of the present disclosure;

FIG. 31 illustrates a diagram of an example codebook according to embodiments of the present disclosure; and

FIG. 32 illustrates an example method 3200 performed by a UE in a wireless communication system according to embodiments of the present disclosure.

### DETAILED DESCRIPTION

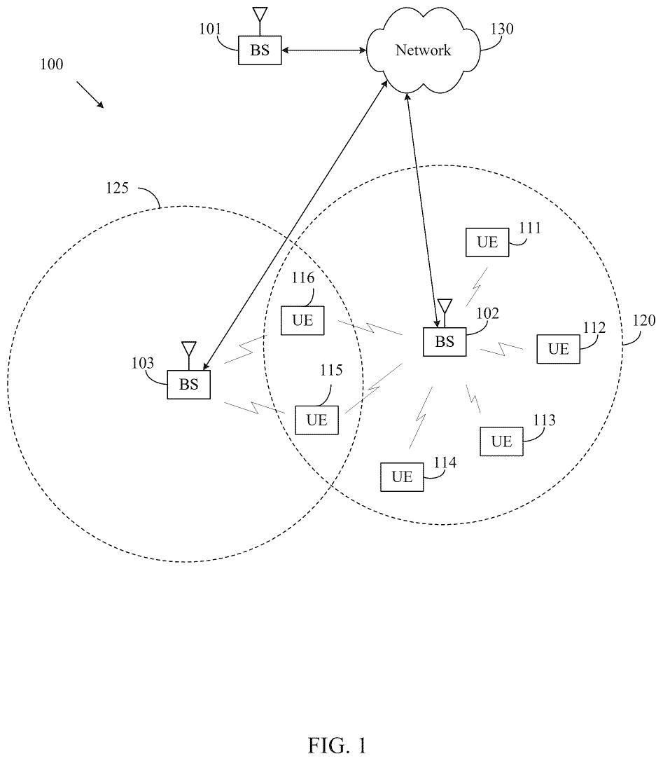

FIGS. 1-32 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 36.211 v17.3.0, “E-UTRA, Physical channels and modulation;” [REF 2] 3GPP TS 36.212 v17.3.0, “E-UTRA, Multiplexing and Channel coding;” [REF 3] 3GPP TS 36.213 v17.3.0, “E-UTRA, Physical Layer Procedures;” [REF 4] 3GPP TS 36.321 v17.3.0, “E-UTRA, Medium Access Control (MAC) protocol specification;” [REF 5] 3GPP TS 36.331 v17.3.0, “E-UTRA, Radio Resource Control (RRC) Protocol Specification;” [REF 6] 3GPP TR 22.891 v1.2.0; [REF 7] 3GPP TS 38.212 v18.0.0, “E-UTRA, NR, Multiplexing and Channel coding;” [REF 8] 3GPP TS 38.214 v18.0.0, “E-UTRA, NR, Physical layer procedures for data;” [REF 9] 3GPP TS 38.211 v18.0.0, “E-UTRA, NR, Physical channels and modulation;” [REF 10] 3GPP TS 38.104 v18.3.0, “E-UTRA, NR, Physical channels and modulation;” [REF 11] O-RAN.WG4.CONF.0-R003-v09.00, “O-RAN Working Group 4 (Fronthaul Working Group) Conformance Test Specification;” and [REF 12] O-RAN.WG4.CUS.0-R003-v13.00, “O-RAN Working Group 4 (Open Fronthaul Interfaces WG)—Control, User and Synchronization Plane Specification.

FIGS. 1-20 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for on measurement and reporting. In certain embodiments, one or more of the BSs 101-103 include circuitry, programing, or a combination thereof to support on measurement and reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

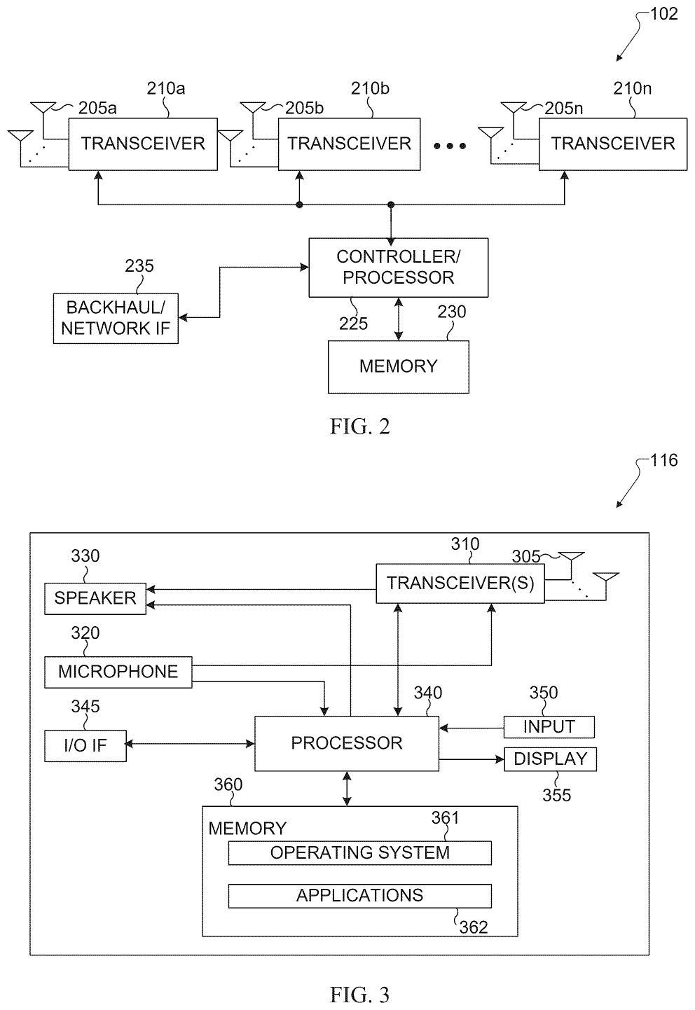

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for on measurement and reporting. Any of a wide variety of other functions could be supported in the gNB 102 by the controller/processor 225.

The controller/processor 225 is also capable of executing programs and other processes resident in the memory 230, such as processes to support on measurement and reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for on measurement and reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

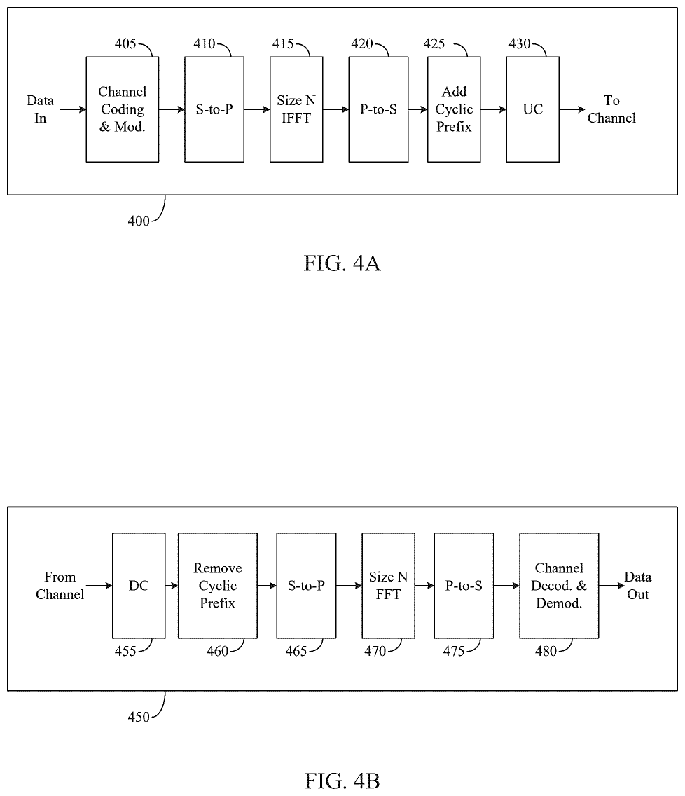

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for on measurement and reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

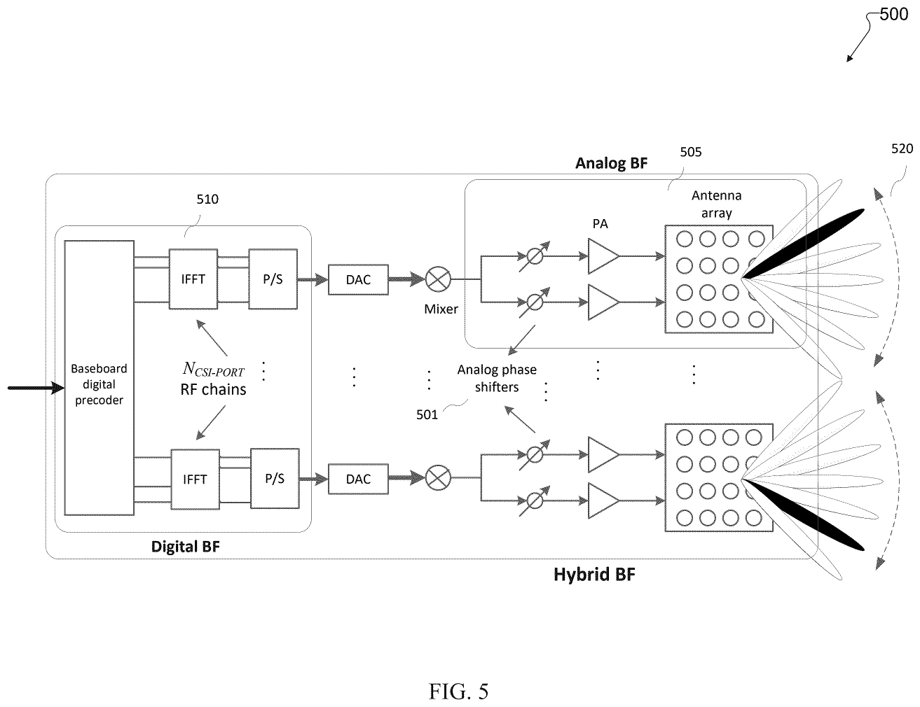

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state indication CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The present disclosure relates generally to wireless communication systems and, more specifically, to next generation of MIMO systems.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNodeB transmits DCI through a Physical DL Control CHannel (PDCCH) or an Enhanced PDCCH (EPDCCH)—see also REF 3. An eNodeB transmits acknowledgement information in response to data Transport Block (TB) transmission from a UE in a Physical Hybrid ARQ Indicator CHannel (PHICH). An eNodeB transmits one or more of multiple types of RS including a UE-Common RS (CRS), a Channel State Information RS (CSI-RS), or a DeModulation RS (DMRS). A CRS is transmitted over a DL system BandWidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe (or slot) and can have, for example, duration of 1 millisecond.

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes of frequency resource units referred to as Resource Blocks (RBs). Each RB includes of

$${N}_{sc}^{RB}$$

sub-carriers, or Resource Elements (REs), such as 12 REs. A unit of one RB over one subframe (or slot) is referred to as a PRB. A UE can be allocated M_{PDSCH} RBs for a total of

$${M}_{sc}^{PDSCH} = {M}_{PDSCH} \cdot {N}_{sc}^{RB}$$

REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, Rank Indicator (RI), and Channel State Information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

An UL subframe (or slot) includes two slots. Each slot includes

$${N}_{symb}^{UL}$$

symbols for transmitting data information, UCI, DMRS, or SRS. A frequency resource unit of an UL system BW is a RB. A UE is allocated N_{RB} RBs for a total of

$${N}_{RB} \cdot {N}_{sc}^{RB}$$

REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is

$${N}_{symb} = 2 \cdot ( {N}_{symb}^{UL} - 1 ) - {N}_{SRS} ,$$

where N_{SRS}=1 if a last subframe (or slot) symbol is used to transmit SRS and N_{SRS}=0 otherwise.

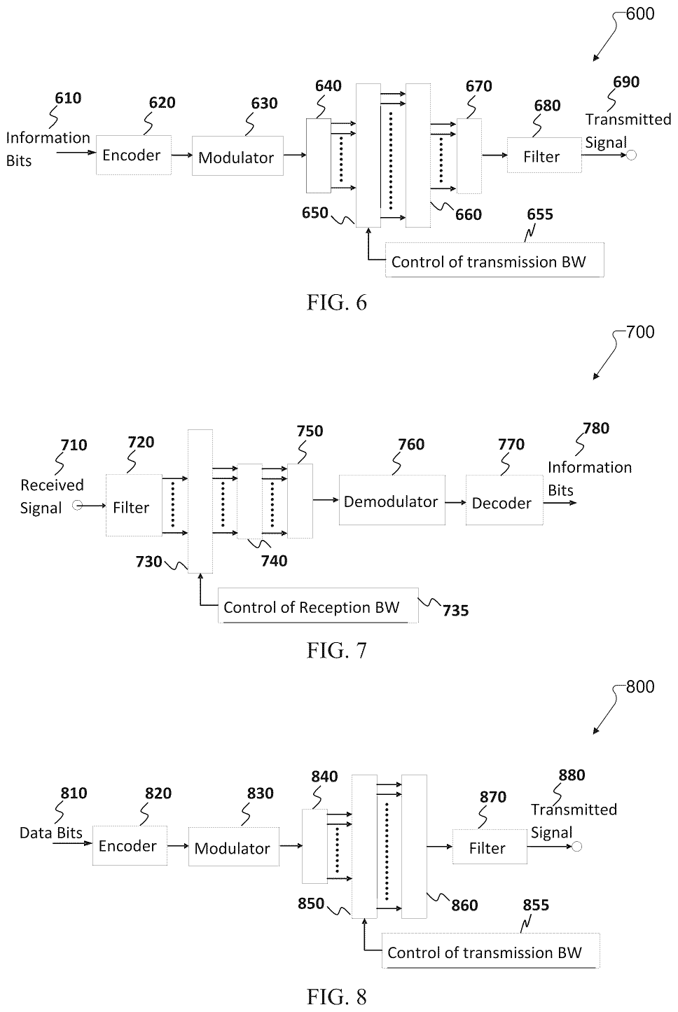

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

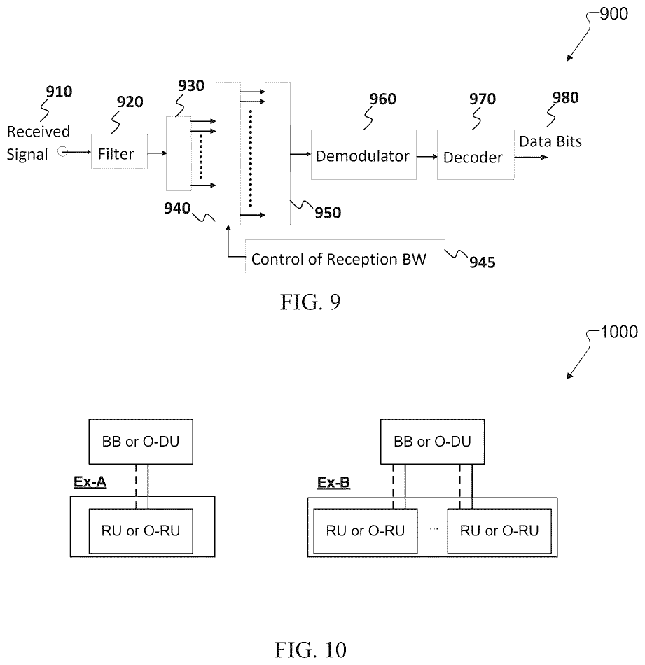

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 0

| Frequency range designation | Corresponding frequency range |
|---|---|
| FR1 | 450 MHz-600 MHz |
| FR2 | 24250 MHz-52600 MHz |

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW (e.g., the network 130) deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of radio RF/hardware (HW)-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

In next generation cellular standards (e.g. 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking into account carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiuser MIMO (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a distributed MIMO (D-MIMO) or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

FIG. 10 illustrates a diagram of example RAN configurations 1000 according to embodiments of the present disclosure. For example, RAN configurations 1000 can be implemented by the BS 102 of FIG. 1. This example is for illustration only and other embodiments can be used without departing from the scope of the present disclosure.

In an O-RAN, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2×)
More than one RUs or O-RUs
One or more than one RUs or O-RUs

Two examples are shown in FIG. 10.

The following are defined in [REF11 and REF12].

| | |
|---|---|
| O-CU | O-RAN Central Unit - a logical node hosting PDCP, RRC, SDAP and other control |
| | functions |
| O-DU | O-RAN Distributed Unit: a logical node hosting RLC/MAC/High-PHY layers based |
| | on a lower layer functional split. O-DU in addition hosts an M-Plane instance. |
| O-RU | O-RAN Radio Unit: a logical node hosting Low-PHY layer and RF processing based |
| | on a lower layer functional split. This is similar to 3GPP's “TRP” or “RRH” but |
| | more specific in including the Low-PHY layer (FFT/iFFT, PRACH extraction). O- |
| | RU in addition hosts M-Plane instance. |

A typical up to 5G network (NW) can be described in terms of transmit-receive points (TRPs). For a first frequency range (FR1), i.e., <6 GHz, a TRP can comprise one or more antenna ports, and is fully-digital (i.e. each antenna port is driven by a dedicated baseband processing chain); and for a second frequency range 24.25-52.6 GHZ (FR2), i.e., for mmWave frequencies, a TRP comprises one of more antenna panels (sub-arrays), each comprising one or two antenna ports that are controlled by analog phase shifters that result in an analog beam (pointing in certain spatial direction). An antenna port in FR1 can also be beamformed (aka virtualization); however, such a beamforming (BF) is generally static (non-adaptive, hence not requiring measurement and reporting). In FR2, due to large propagation loss at mmWave frequencies, each antenna panel requires dynamic frequent update of the analog BF, which is often based on (analog) beam measurement and reporting.

A communication between the 5G NW and a user is broadly based on: (A1) NW resources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP (sTRP) or multiple TRPs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of PRBs, and the TD resources can comprise one or multiple time slots (i.e., 1 slot=N_{sym} consecutive symbols).

The signaling components include signaling associated with (D1) measurement, (D2) channel state information (CSI) report, and (D3) DL reception or UL transmission.

For (D1), the user measures channel measurement RSs (CMRs) to estimate the channel condition between the sTRP/mTRP and the user. In case of sTRP, the user can measure a set comprising one or multiple DL measurement resources. For mTRP, the measurement resources can be (E1) one resource set comprising one group per TRP, or (E2) one resource set per TRP. The user can also measure the interference based on interference measurement RSs (IMRs). A CMR can correspond to an analog beam, and can be repeated in multiple symbols for determining user's analog beam.

For (D2), the user, based on the measurement, determines the CSI and reports it to the NW, where the CSI can be (F1) (analog) beam-related CSI, or (F2) (digital) non-beam-related CSI. For (F1), the user determines one or multiple pairs (indicator, metric), where the indicator indicates a CMR and the metric indicates a (beam) quality (e.g. reference signal received power (RSRP), signal-to-interference-plus-noise ratio (SINR)).

For (F2), a low-resolution (Type-I) CSI and a high-resolution (Type-II) CSI are supported. The Type-I CSI is based on L=1 DFT SD vector per layer, requires low feedback overhead and is expected to work reasonably well for single user (SU)-MIMO. For multiuser-(MU-)MIMO transmission, however, high-resolution Type II CSI capturing multiple dominant directions of the channel is essential in order to suppress inter-user interference. The Type-II CSI is based on a weighted linear combination L>1 SD DFT vectors where the weights correspond to coefficients. The FD DFT vectors were additionally introduced enhanced Type-II CSI to reduce the CSI feedback overhead by compressing channel coefficients in both SD and FD. A further enhanced Type-II port-selection (PS) CSI was specified to further reduce the CSI overhead by exploiting a reciprocity of angle-and-delay domain between uplink and downlink channels. Expecting NW performs pre-processing with beamformed CSI-RS to concentrate angle-and-delay domain components in few SD and FD basis directions, the user can be configured to select a subset of antenna ports (at a TRP) and one or two FD vectors. Additionally, a NCJT Type-I CSI was supported for up to two TRPs and multiple (sTRP or NCJT) hypotheses. Furthermore, the enhanced Type-II CSI is extended to support CJT Type-II CSI from mTRP and for high/medium user velocities exploiting time-domain correlation or Doppler-domain information, respectively.

A transmission configuration indication (TCI) framework is shared between (non-beam-related) CSI and beam management (BM). While the complexity of such a TCI framework is justified for CSI acquisition in FR1, it makes BM procedures less efficient in FR2. Furthermore, the BM procedures can be different for different channels due to their different target scenarios. Having different beam indication/update mechanisms increases the complexity, overhead, and latency of BM. Such drawbacks are especially troublesome for high mobility scenarios (such as highway and high-speed train). These drawbacks motivated a streamlined BM framework for beam-based operations and procedures that is common for data and control, and uplink (UL) and downlink (DL) channels. This framework is referred to as a unified TCI (uTCI) framework, firstly introduced for sTRP and now being enhanced for mTRP.

The uTCI framework supports signaling of a unified TCI state to a user, where the unified TCI state can be a DL-TCI, an UL-TCI or a joint TCI (J-TCI) state, where a DL-TCI state is applied for receiving DL channels/signals, an UL-TCI state is applied for transmitting UL channels/signals, and a J-TCI state is applied for both DL and UL channels/signals. The uTCI framework is designed to support DL receptions and UL transmissions (i) with a joint (common) beam indication for DL and UL by leveraging beam correspondence (reciprocity between DL and UL), and (ii) with separate beam indications for DL and UL, for example to mitigate maximum permissible exposure, where the beam direction of an UL transmission is different from the beam direction of a DL reception to avoid exposure of the human body to radiation.

The uTCI framework can support a beam-level mobility, known as inter-cell BM (ICBM). In ICBM, the user-dedicated channels can be configured to use a beam (i.e., TCI state) associated with a (non-serving) cell having a physical cell identity (PCI) that is different from the PCI of the serving cell. This allows fast beam-switch to a non-serving cell for user-dedicated channels at a lower layer without involving a higher layer and without incurring latency and overhead of handover.

The ICBM is being further enhanced to support a complete cell-switch triggered by lower layers, which is known as lower-layer triggered mobility (LTM). In LTM, the NW can acquire beam measurements, and UL timing information for target candidate cells before cell-switch. The lower layers of the NW decide when to perform a cell-switch, and send a medium access control channel element (MAC CE) containing a cell-switch command (CSC) that triggers the cell-switch from a source cell to a target cell. The CSC includes beam (i.e., TCI state) and UL timing information for the user to use on the target cell. After a beam application delay, the user and the NW communicates via the target cell.

NW energy saving (NES) is another advanced feature, wherein the NW can optimize energy usage by turning TRPs ON/OFF, thereby saving power. From a user's perspective, this is akin to dynamic SD resource update between transmissions. The CSI in the NES scenario can be based on multiple sub-configurations, each corresponding to different SD resource assignments, and dynamically (via DCI) triggering one or multiple of the sub-configurations for CSI reporting.

Full-duplex transmission and reception in the same NR channel BW or using non-contiguous intra-band carrier aggregation (CA) is a promising technology to enhance UL coverage, reduce latency and improve system capacity and to overcome limitations inherent to the use of de-facto mandated semi-static TDD UL-DL frame configurations in today's NR TDD deployments. Currently, 3GPP is studying benefits, feasibility and deployment scenarios for enabling NW-side full-duplex operation where simultaneous transmissions and receptions by the NW on the same time-domain symbol on the NR carrier can only occur in non-overlapping UL and DL subbands, e.g., subband full-duplex (SBFD) mode. In this first step of NR duplex evolution, users with support for NW-side SBFD operation still operate in half-duplex, i.e., the user can either transmit or receive on an SBFD symbol but not transmit and receive simultaneously. An SBFD UL subband can be located in the center or at the edge of the NR carrier in FR1 or FR2-1. For CA-based SBFD in FR2-1, one component carrier (CC) is allocated for UL transmissions whereas the remaining CCs are used for DL transmission.

NW-side self-interference cancellation (SIC) capability to enable SBFD can be realized through a combination of solutions. For example, the NW can use Tx/Rx antenna isolation on the antenna panel(s), beam steering, analog and/or digital pre-distortion, digital interference cancellation, and analog and/or digital filtering solutions. Note that passive Tx/Rx antenna isolation has been demonstrated to achieve in excess of 80 dB in FR1 with even higher isolation in FR2-1. For example, SBFD for the Local Area base station class characterized by small Tx power and reduced Rx sensitivity can already achieve a significant amount of SIC capability by relying on antenna isolation alone. Wide Area base stations characterized by much higher transmit power and higher Rx sensitivity may need to implement a more extensive set of solutions to support SBFD.

NW-side SBFD operation can be enabled transparently for typical NR users and has been shown feasible and providing gains. In this case, typical users are scheduled UL transmissions in the SBFD UL subband of the NR carrier on symbols configured as flexible by SIB1. More gains in the NR TDD cell supporting NW-side SBFD operation can be achieved in presence of SBFD-aware users, e.g., supporting resource allocation enhancements for PDSCH, PUSCH and PUCCH including handling of TCI states and BF, and CSI reporting enhancements to best exploit the link conditions on SBFD and non-SBFD slots/symbols on the serving cell.

As explained, the 5G NW can support several features, services, use cases, and deployment scenarios. It however also introduces too many different abstractions (for specification) of NW entities and involved signaling for components of these abstractions. For instance, the specification supports abstractions for single-cell, multi-cell, sTRP, mTRP, panel, antenna panel, antenna port, resource, resource set, and beam; and signaling for a complicated CSI framework based on components such as CSI resource setting (one or more CSI-RS resources sets, each with one or more CSI-RS/synchronization signal block (SSB) resources) and CSI report setting that links a CSI resource setting to a report quantity from a set of multiple supported report quantities, wherein a report quantity can correspond to beam report (i.e. an analog beam and a beam quality) or a non-beam report (i.e. RI/CQI/PMI/CRI). In addition, for PMI, too many different codebooks are supported. Due to these reasons, deployment of the 5G NW is challenging in reality. A direct scaling/extension/reuse of these typical up to 5G solutions for 6G will add to the complexity, which is undesired in real NW deployments.

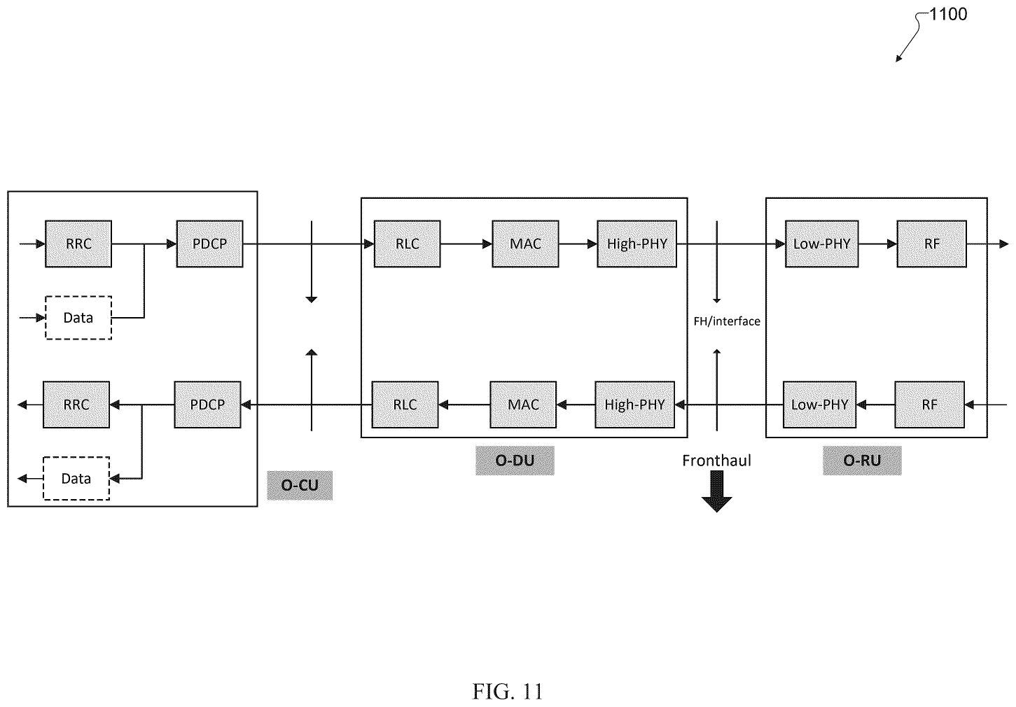

FIG. 11 illustrates a diagram of example functional split points/options 1100 according to embodiments of the present disclosure. For example, functional split points/options 1100 may be implemented by the BS 103 of FIG. 1. This example is for illustration only and other embodiments can be used without departing from the scope of the present disclosure.

Embodiments of the present disclosure recognize that in next-gen MIMO systems (e.g. 6G), at least two aspects need to be evaluated.
(A) 3GPP PHY specification: The significance of a single NW entity, namely PG (as a collection of ports) in terms of port-common channel properties. This is analogous to the 5G QCL (or TCI state), coherency expectation (e.g. FC, PC, NC).
(B) NW architecture as perceived in O-RAN: The functionality split among O-RAN entities for DL and UL operations, such as O-RU, O-DU, and O-CU (as described herein). An example is shown in FIG. 11. In particular, the PHY functionality split between O-DU and O-RU includes at least the following aspects.
   (B1) PHY processing:
      bit-level processing,
      symbol-level processing
   (B2) Scheduling (residing in MAC): SU-MIMO/MU-MIMO scheduling across different O-RUs or/and allocated frequency-domain resources (e.g. PRBs, PRGs, SBs)
      Utilizing UCI carrying CSI
      If DL/UL reciprocity is feasible, also utilizing SRS-based channel measurement
   (B3) Precoder calculation at a gNB (NW side) for DL-SCH transmission:
      For SU-MIMO, precoder can simply follow the PMI (calculated expecting SU-MIMO hypothesis) reported by the UE, or, if DL/UL reciprocity is feasible, be calculated from the eigenvector(s) of the measured DL channels.
      For MU-MIMO, precoder needs to be calculated based on additional orthogonalization (e.g. ZFBF, SLNR) among PMIs, or, if DL/UL reciprocity is feasible, the eigenvectors of the measured channels of the co-scheduled UEs

The first (A) can be achieved by removing/merging duplicate/redundant abstractions, and simplifying signaling for components of the abstractions. One such framework, namely dynamic MIMO, is provided in this disclosure, wherein abstractions such as CSI-RS resource, CSI-RS resource set, port, beam, TRP, panel etc. can be clubbed into one basic entity, namely antenna/port group (PG or O-RU (or RU)), and essential features of PGs are specified. A few essential features discussed include dynamic PG or O-RU (or RU) selection and long-term stats and expectations across PGs, e.g., quasi co-location (QCL) and coherency relationships across PGs. The provided framework can also facilitate fast and accurate CSI acquisition, where the CSI can be beam-related (e.g. beam indicator, beam metric), non-beam-related (e.g. rank indicator (RI)/precoding matrix indicator (PMI)/channel quality indicator (CQI)), or both. Additionally, the concept of a cell is replaced with PGs that are distributed through the NW. The mobility can be handled via the PG or O-RU (or RU) selection/update (from one set of PGs to another set of PGs).

A few relevant (more-probable) candidates discussed in the O-RAN Alliance (depicted in FIG. 11) are shown in Table 1.

TABLE 1
(both DL and UL)

| | | | | | | | |
|---|---|---|---|---|---|---|---|
| | | | High- | Low- | | | |
| PDCP | RLC | MAC | PHY | PHY | RF | HLS | LLS |

| | | | | | |
|---|---|---|---|---|---|
| O-RAN¹ | O-CU: | O-DU: RLC, | O-RU: | Y | symbol- |
| (Opt7-2x) | PDCP | MAC, High-PHY | Low-PHY, RF | | level PHY |
| Opt7-3 | O-CU: | O-DU: RLC, | O-RU: | Y | bit- |
| | PDCP | MAC, High-PHY | Low-PHY, RF | | level PHY |

| | | | | |
|---|---|---|---|---|
| Opt8 | DU: RLC, MAC, PHY | RU: RF | Y | CPRI |

O-RAN¹: [REF 12]
Cat-A, Cat-B
UL: Cat-C

The 5G NR MIMO inherits a number of unnecessary hierarchical specification entities from 4G LTE. In relation to multi-antenna (MIMO), such entities include:
Pointless “middlemen” abstractions: resource and resource-set entities for RS
Obsolete implementation-based abstractions: panel, multi-panel, “TRP”, FR1 port vs FR2 beam/resource, “cell”

Going into 6G, the MIMO framework should be simplified/streamlined in order to (i) support both typical (up to 5G) and new frequency bands (e.g. FR3), (ii) enable new features/services (such as AI/ML-based learning, evolved duplexing, and energy saving), (iii) make it implementation friendly, and (iv) have a future-proof and easily upgradable system.

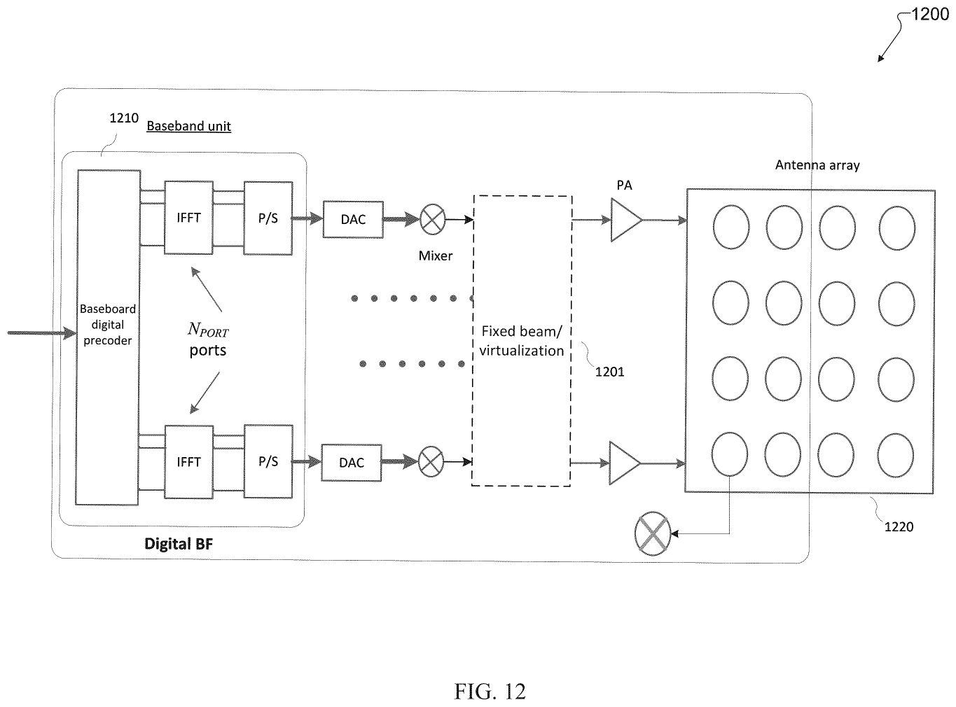

FIG. 12 illustrates an example of a fully digital transmitter structure 1200 for beamforming according to embodiments of the present disclosure. For example, fully digital transmitter structure 1200 can be implemented in the BS 102 of FIG. 2. This example is for illustration only and other embodiments can be used without departing from the scope of the present disclosure.

The fully digital transmitter structure 1200 includes a digital beamformer 1210, a fixed beam/virtualization 1201, and antenna array angles 1220.

A 5G NW can be built upon a spatial resource entity, say X. For a first frequency range (FR1), i.e., <6 GHz, the spatial entity X comprises one or more antenna ports that are fully-digital (i.e. each antenna port is driven by a dedicated baseband processing chain), as shown in FIG. 12; and for a second frequency range 24.25-52.6 GHz (FR2), i.e., for mm Wave frequencies, the entity X comprises one or more antenna panels (sub-arrays), each comprising one (or two) antenna ports that is (are) controlled by analog phase shifters that result in an analog beam (pointing in certain spatial direction), as shown in FIG. 5. An antenna port in FR1 can also be beam-formed (aka virtualization); however, such a beamforming (BF) is generally static (non-adaptive, hence does not requiring measurement and reporting). In FR2, due to large propagation loss at mmWave frequencies, each antenna panel requires dynamic frequent update of the analog BF, which is often based on (analog) beam measurement and reporting.

Thus, the main difference between a FR1 port and a FR2 panel is that the beam/virtualization (i.e. port assignment) is fixed in the former, and it requires (a) measurement and reporting from UE (e.g., the UE 116) and (b) a beam indication from the NW (TCI state with QCL-TypeD). It is therefore plausible to have a unified framework in which a port in FR1 and a panel in FR2 can be abstracted based on a unified, band-agnostic spatial entity, e.g. port or port group (PG), and associated QCL and coherency properties across ports or PGs (intra-/inter PG). For instance,
Port: a FR1 port and a FR2 beam/source
Port group (PG): TRP, resource, resource set, panel, cell

While the O-RAN Alliance is intended for 5G NR, it is expected that its framework will continue, or at most refined, for 6G. The O-RAN Alliance specifies 3 levels of functional splits—namely CU, DU, and RU—to facilitate multi-vendor inter-operability within a NW. The manner in which PHY-layer functions are split between DU and RU(s) imposes serious impact on the feasibility, performance, and complexity of different MIMO schemes—mainly due to the latency and quantization loss incurred by the O-RAN-standardized RU-DU interface.

Instead of reusing the 4G/5G abstraction of CSI-RS resource or resource set, the terms “port” as a spatial-domain resource unit and “port group” (PG) as a collection of ports sharing a same set of channel properties are used irrespective of the frequency band. In this sense, a “port” can be associated with a digital port in FR1 or an analog beam in FR2 (thereby abandoning the 5G association between an analog beam and a CSI-RS resource for FR2).

The present disclosure relates to next generation MIMO systems (e.g. adv. 5G and 6G). In particular, it relates to a dynamic MIMO operations based on a single basis entity, namely antenna/port group (PG), that can be useful for a wide range of applications such as common MIMO (FR1), beam-formed MIMO (FR2 and beyond), dynamic port assignment for network energy saving and duplexing operations, predictive MIMO (mobility scenarios) etc.:
PG: configurability depending on use case and scenarios
   Example of PG: port, beam (QCL Type D source RS), panel, TRP, CSI-RS resource etc.
Multiple MIMO hypotheses
Long-term stats and expectations across PGs
   QCL relationship
   Coherency (full, partial, non-coherent)
Supporting advanced features such as mobility, network (e.g., the network 130) energy saving, duplexing, user-initiated beam management etc.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both frequency division duplexing (FDD) and time division duplexing (TDD) are provided as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure of disclosure covers several components which can be used in conjunction or in combination with one another, or can operate as standalone schemes.

Depending on the network type, the term “base station” or “BS” can refer to any component (or collection of components) configured to provide wireless access to a network, such as transmit point (TP), transmit-receive point (TRP), an enhanced base station (eNodeB or eNB), gNB, a macrocell, a femtocell, a WiFi access point (AP), or other wirelessly enabled devices. Base stations may provide wireless access in accordance with one or more wireless communication protocols, e.g., 5G 3GPP New Radio Interface/Access (NR), long term evolution (LTE), LTE advanced (LTE-A), High Speed Packet Access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

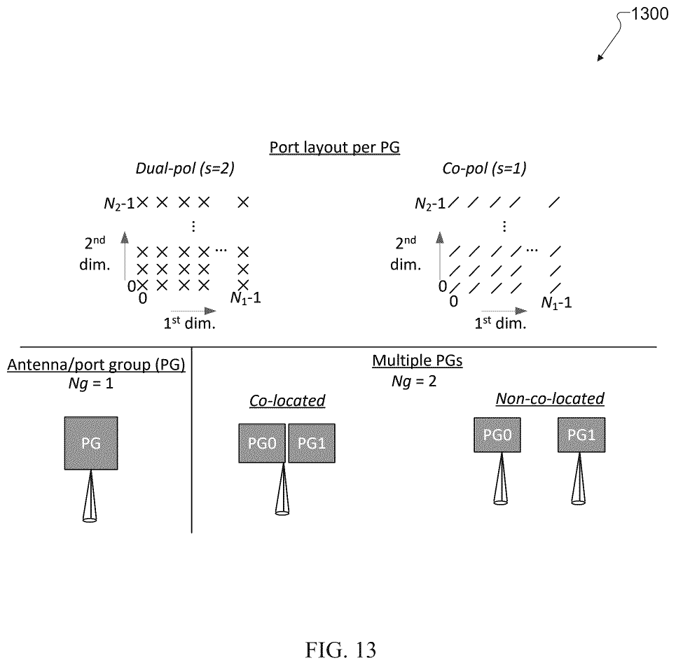

FIG. 13 illustrates a diagram of an example antenna port layout 1300 according to embodiments of the present disclosure. For example, antenna port layout 1300 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 13 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 ,$$

. . . , X+P_{CSIRS}−1 comprise a second antenna polarization, where P_{CSIRS} is a number of CSI-RS antenna ports and X is a starting antenna port number (e.g. X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=sN₁N₂.

Let N_{g} be a number of antenna/port groups (PGs). When there are multiple antenna/port groups (N_{g}>1), each group (g∈{1, . . . , N_{g}}) comprises N_{1,g} and N_{2,g} ports in two dimensions. This is illustrated in FIG. 13. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g} (for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g. comprising a CSI-RS resource set).

In one example, an antenna/port group corresponds to a reconfigurable intelligent surface (RIS) in which the antenna/port group can be (re-)configured more dynamically (e.g. via MAC CE or/and DCI). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 13. The antenna structure at each PG or O-RU (or RU) can be the same. Or the antenna structure at an PG or O-RU (or RU) can be different from another PG or O-RU (or RU). Likewise, the number of ports at each PG (OR O-RU OR RU) can be the same. Or the number of ports at one PG (OR O-RU OR RU) can be different from another PG (OR O-RU OR RU).

In another example, the antenna architecture of the MIMO system is unstructured. For example, the antenna structure at one PG (OR O-RU OR RU) can be different from another PG (OR O-RU OR RU).

A structured antenna architecture is expected in the rest of the disclosure. For simplicity, each PG (OR O-RU OR RU) is equivalent to a panel (cf. FIG. 13), although, an PG (OR O-RU OR RU) can have multiple panels in practice. The disclosure however is not restrictive to a single panel expectation at each PG (OR O-RU OR RU), and can easily be extended (covers) the case when an PG (OR O-RU OR RU) has multiple antenna panels.

In one or more embodiments described herein, an PG (OR O-RU OR RU) constitutes (or corresponds to or is equivalent to) at least one of the following:
In one or more examples described herein, an PG OR O-RU (OR RU) corresponds to a TRP.
In one or more examples described herein, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure herein.
In one or more examples described herein, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one or more examples described herein, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one or more examples described herein, an PG or O-RU (or RU) corresponds to or more examples described herein depending on a configuration. For example, this configuration can be explicit via a parameter (e.g. an RRC parameter). Or it can be implicit.
In one example, when implicit, it could be based on the value of K. For example, when K>1 CSI-RS resources, an PG or O-RU (or RU) corresponds to or more examples described herein, and when K=1 CSI-RS resource, an PG or O-RU (or RU) corresponds to or more examples described herein.
In another example, the configuration could be based on the configured codebook. For example, an PG or O-RU (or RU) corresponds to a CSI-RS resource or resource group when the codebook corresponds to a decoupled codebook (modular or separate codebook for each PG or O-RU (or RU)), and an PG or O-RU (or RU) corresponds to a subset (or a group) of CSI-RS ports when codebook corresponds to a coupled (joint or coherent) codebook (one joint codebook across PGs).

In one example, when PG or O-RU (or RU) maps (or corresponds to) a CSI-RS resource or resource group, and a UE can select a subset of PGs (resources or resource groups) and report the CSI for the selected PGs (resources or resource groups), the selected PGs can be reported via an indicator. For example, the indicator can be a CRI or a PMI (component) or a new indicator.

In one example, when PG or O-RU (or RU) maps (or corresponds to) a CSI-RS port group, and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs, a decoupled (modular) codebook is used/configured, and when a single (K=1) CSI-RS resource for N_{g} PGs, a joint codebook is used/configured.

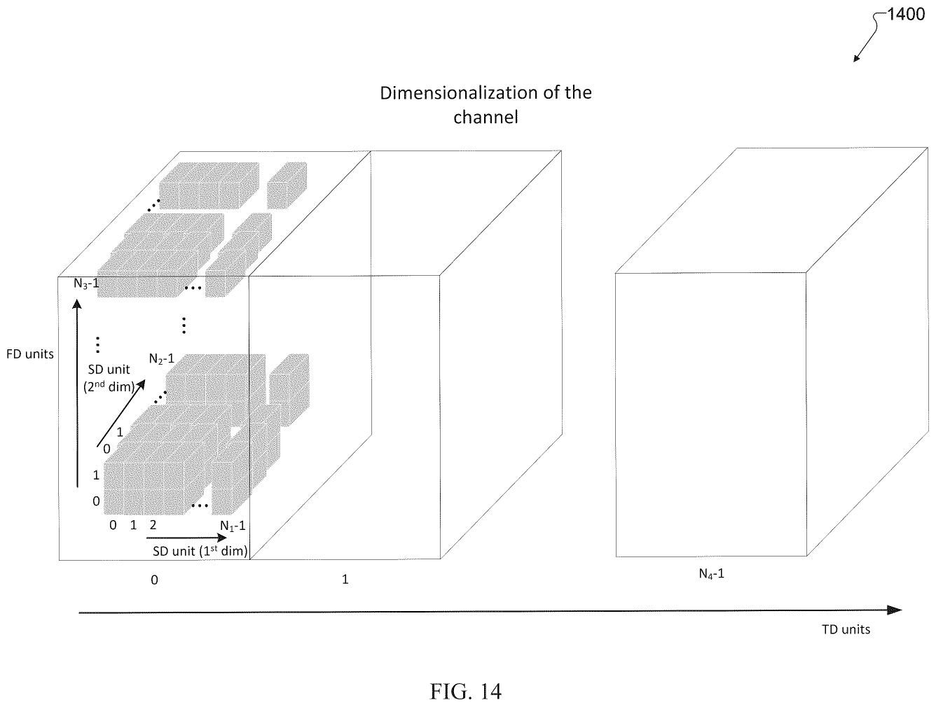

FIG. 14 illustrates a timeline 1400 of example SD units and FD units according to embodiments of the present disclosure. For example, timeline 1400 can be followed by any of the UEs 111-116 of FIG. 1. This example is for illustration only and other embodiments can be used without departing from the scope of the present disclosure.

In one embodiment, a UE is configured (e.g. via a higher layer CSI configuration information) with a CSI report, where the CSI report is based on a channel measurement (and interference measurement) and a codebook. When the CSI report is configured to be aperiodic, it is reported when triggered via a DCI field (e.g. a CSI request field) in a DCI.

The channel measurement can be based on K≥1 channel measurement resources (CMRs) that are transmitted from a plurality of spatial-domain (SD) units (e.g. a SD unit=a CSI-RS antenna port), and are measured via a plurality of frequency-domain (FD) units (e.g. a FD unit=one or more PRBs/SBs) and via either a time-domain (TD) unit or a plurality of TD units (e.g. a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1^{st} and 2^{nd} antenna dimensions), FD units, and, and TD units is shown in FIG. 14.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g. co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG comprising P_{CSIRS} ports, and the CSI report is based on the channel measurement from the one PG.
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG (one-to-one mapping). In one example, multiple CMRs can correspond to an PG (many-to-one mapping).

In one example, when of the P_{CSIRS} antenna ports are co-located at one site, N_{g}=1. In one example, when of the P_{CSIRS} antenna ports are distributed (non-co-located) across multiple sites, N_{g}>1.

In one example, when of the P_{CSIRS} antenna ports are co-located at one site and within a single antenna panel, N_{g}=1. In one example, when of the P_{CSIRS} antenna ports are distributed across multiple antenna panels (can be co-located or non-co-located), N_{g}>1.

The value of N_{g} can be configured, e.g. via higher layer RRC parameter. Or it can be indicated via a MAC CE. Or it can be provided via a DCI field.

Likewise, the value of K can be configured, e.g. via higher layer RRC parameter. Or it can be indicated via a MAC CE. Or it can be provided via a DCI field.

In one example, K=N_{g}=X. The value of X can be configured, e.g. via higher layer RRC parameter. Or it can be indicated via a MAC CE. Or it can be provided via a DCI field.

In one example, the value of K is determined based on the value of N_{g}. In one example, the value of N_{g} is determined based on the value of K.

The plurality of FD units can be associated with a frequency domain allocation of resources (e.g. one or multiple CSI reporting bands, each comprising multiple PRBs) and dimensionalizes the frequency (or delay)-domain profile of the channel measurement.

The plurality of TD units can be associated with a time domain allocation of resources (e.g. one or multiple CSI reporting windows, each comprising multiple time slots) and dimensionalizes the time (or Doppler)-domain profile of the channel measurement.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2KN₁N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is

$${P}_{CSIRS , tot} = {\sum }_{r = 1}^{K} 2 {N}_{1 , r} {N}_{2 , r} .$$

In port numbering scheme 1, the CSI-RS ports are numbered according to the order of (polarization p, NZP CSI-RS resource r) as CSI-RS ports of (p=0, r=1) followed by CSI-RS ports of (p=1, r=1), followed by CSI-RS ports of (p=0, r=2), followed by CSI-RS ports of (p=1, r=2), . . . ,, followed by CSI-RS ports of (p=0, r=N) followed by CSI-RS ports of (p=1, r=N).

In port numbering scheme 2, the CSI-RS ports are numbered according to the order of (polarization p, NZP CSI-RS resource r) as
CSI-RS ports of (p=0, r=1) followed by CSI-RS ports of (p=0, r=1), . . . ,, followed by CSI-RS ports of (p=0, r=N), and
then CSI-RS ports of (p=1, r=1) followed by CSI-RS ports of (p=1, r=1), . . . ,, followed by CSI-RS ports of (p=1, r=N).

In one example, an PG corresponds to an antenna, an antenna group (multiple antennae), an antenna port, an antenna port group (multiple ports), a CSI-RS resource, a CSI-RS resource set, a group of CSI-RS resources, a panel, an RRH, a Tx-Rx entity, a (analog) beam, a (analog) beam group, a cell, a cell group.

In one example, PGs can have a uniform (the same/common) structure. For example, they can have the same number of ports (P_{CSIRS,r}=P_{CSIRS}) or the same antenna port layout (N_{1,r}, N_{2,r})=(N₁, N₂). In one example, PGs can have non-uniform (or different) structure. For example, they can have the same or different number of ports (P_{CSIRS,r}_{₁}=P_{CSIRS,r}_{₂} or P_{CSIRS,r}_{₁}≠P_{CSIRS,r}_{₂}) or the same antenna port layout, i.e., (N_{1,r}_{₁}, N_{2,r}_{₁})=(N_{1,r}_{₂}, N_{2,r}_{₂}) or (N_{1,r}_{₁}, N_{2,r}_{₁})+(N_{1,r}_{₂}, N_{2,r}_{₂}).

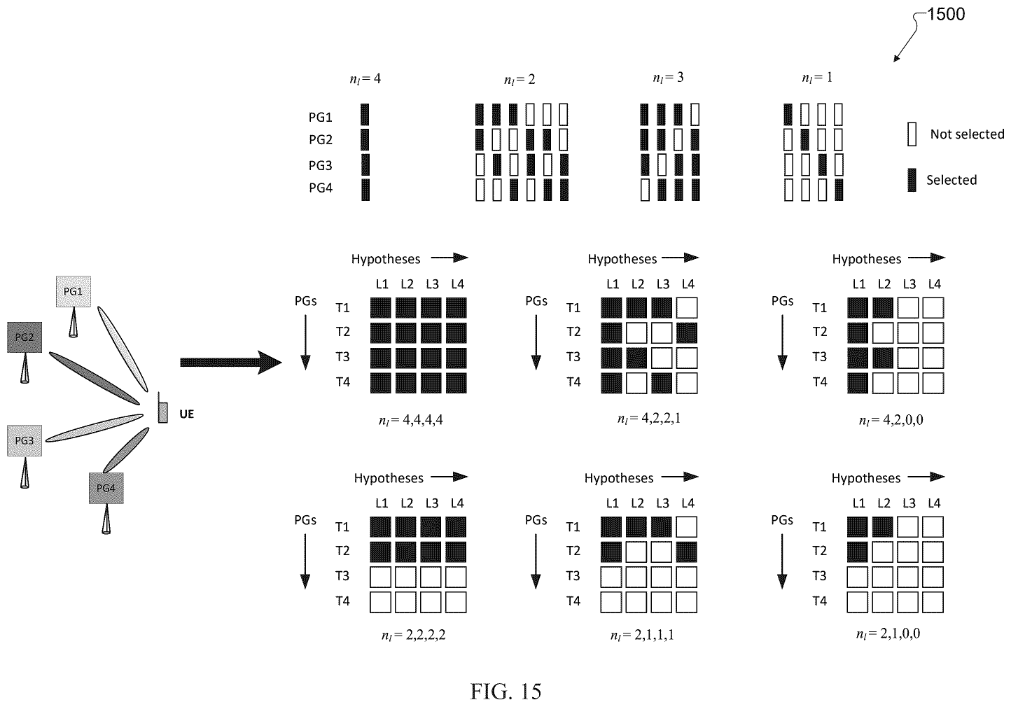

FIG. 15 illustrates a diagram of example PG hypotheses 1500 according to embodiments of the present disclosure. For example, PG hypotheses 1500 can be utilized by the BS 102 of FIG. 2. This example is for illustration only and other embodiments can be used without departing from the scope of the present disclosure.

In one embodiment, a user is configured with a dynamic (flex-) MIMO framework based on a single basic NW entity, namely a port group (PG) is provided. The basic NW entity can be an O-RAN RU. A PG can be an abstraction for antenna panel (N_{g}=1), TRP (N_{g}≥1), CSI-RS antenna ports of a NZP CSI-RS resource (N_{g}=1), a subset of CSI-RS antenna ports of a NZP CSI-RS resource (N_{g}≥1), CSI-RS antenna ports of multiple NZP CSI-RS resources comprising a CSI-RS resource set. The MIMO operations in the provided framework includes at least three steps:
1) NW configuring a UE (e.g., the UE 116) to measure N_{g}≥1 PGs
2) The selection of at least one PG selection hypothesis
3) CSI reporting and DL-precoding according to the at least one of the PG selection hypotheses.

Let Y≥1 be a number of PG selection hypotheses. An example is shown in FIG. 15, wherein N_{g}=4, and six examples of PG selection hypotheses are shown. For each l∈{1, . . . , Y}, an PG selection hypothesis selects nₗ PGs, where 1≤nₗ≤N_{AG}. The PG selection can either be user-reported (performed by the user, and reported to the NW), or NW-controlled (performed by the NW, and indicated to the user), and can either be a standalone/separate or a non-standalone procedure. When non-standalone, the PG selection can be included or/and multiplexed either with a DL indication such as beam or TCI state indication, or with a report (e.g. CSI or beam report). When user-reported, the PG selection report includes an information about the selected {nₗ} PGs, and can also include a metric (e.g. RSRP, power level, SINR). The PG selection is signaled dynamically, e.g., via a MAC CE or a DCI or a DCI with MAC CE activation (similar to beam/TCI state indication) or via UCI (similar to aperiodic beam/CSI report). Note that the PG selection can support both NW-controlled features such as beam (TCI state) indication, TRP indication (CJT), port indication (non-PMI feedback), sub-configurations (NES), and SBFD (duplexing); and User-reported features such as dynamic TRP selection (CJT), dynamic port selection (PS T2 codebook).

Depending on the antenna architecture (fully digital vs hybrid), a PG can comprise one or more than one antenna port, wherein the port can be with a fixed beam/virtualization, or a dynamic beam/virtualization. Likewise, in mobility scenarios, the PG selection can be via layer 1 control in order to facilitate fast PG selection switch/update.

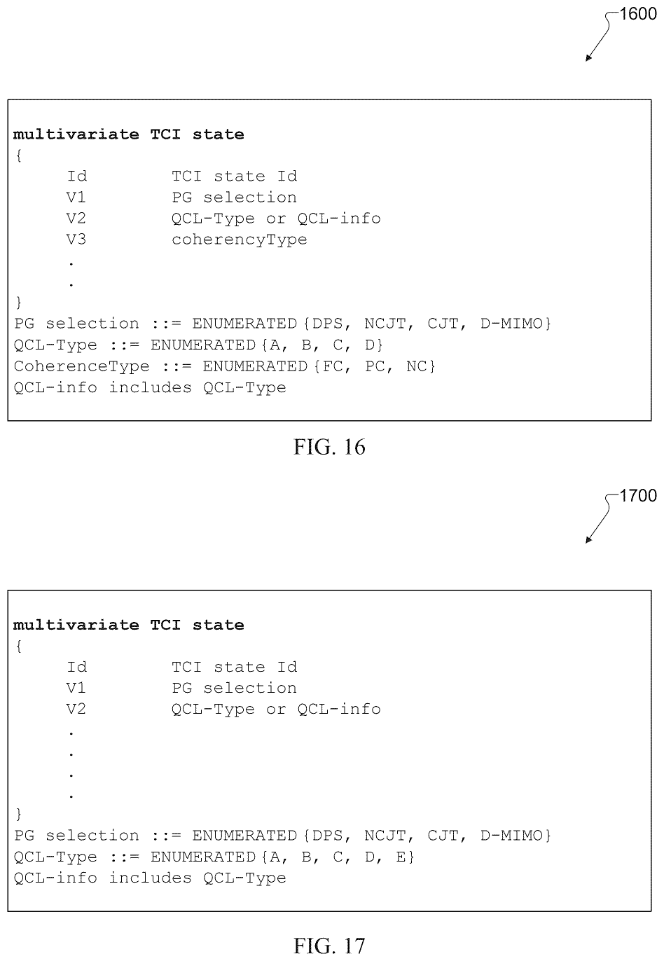

FIG. 16 illustrates a diagram of an example TCI state configuration 1600 according to embodiments of the present disclosure. For example, TCI state configuration 1600 can be configured by the BS 103 of FIG. 1. This example is for illustration only and other embodiments can be used without departing from the scope of the present disclosure.

FIG. 17 illustrates a diagram of an example TCI state configuration 1700 according to embodiments of the present disclosure. For example, TCI state configuration 1700 can be configured by the BS 102 of FIG. 1. This example is for illustration only and other embodiments can be used without departing from the scope of the present disclosure.

In one embodiment, properties/assumptions associated with port(s) of the one or multiple PGs need to be established. Two main properties include: (a) QCL relation and (b) coherency. As for (a), it refers to channel properties that are common across ports associated with PGs, and (b) refers to transmission/reception hypothesis using multiple ports within/across PG(s). In NR MIMO, (a) and (b) are treated separately. In particular, for DL, (a) is via TCI state, and (b) is via assumed transmission hypothesis (such as single-panel, multi-panel, sTRP, mTRP DPS, mTRP NCJT, mTRP CJT etc.). Likewise, for UL, (a) is via SRI or joint TCI state or UL TCI state, and (b) is via TPMI. Also, there are two separate indications for Rel.17 uTCI, i.e. UL TCI state indication via DL-DCI and TPMI indication via UL-DCI. Such a decoupled design clearly is unnecessary and inefficient, especially for layer 1 control signalling. It can be coupled into one by consolidating all variables (and associated properties) into one indication framework. One such framework, namely multivariate TCI state, is proposed as follows.

In one embodiment, the ports within a PG can be associated with properties regarding QCL (or TCI state) and coherency. A multivariate TCI framework for acquiring/indicating these properties is used, where the multivariate TCI state definition includes at least one or more of the following:
PG selection hypotheses (e.g. for schemes DPS, NCJT, CJT, D-MIMO or seamless mobility)
QCL relation.
Coherency within/across PGs

For QCL, relevant channel properties include (i) angular profile such as spatial filter parameter (analog beam), (ii) Delay profile such as average delay, delay spread, and (iii) Doppler profile such as Doppler shift, Doppler spread.

Quasi co-location (QCL) assumptions correspond to LT channel properties that are common across antenna ports associated with PGs. A few examples of QCL relations are as follows:
{Doppler shift, Doppler spread, average delay, delay spread}
{Doppler shift, Doppler spread}
{Doppler shift, average delay}
{Spatial filter parameter}

The following are viable options for coherency.
Option 1: coherency based on new QCL-info or QCL-type (e.g. Type E) into the QCL or TCI-state definition
Option 2: coherency and the PG selection hypothesis are included in the QCL or TCI-state definition
Option 3: coherency is separate from QCL-info or TCI state definition. It can be a dedicated IE or RRC parameter, e.g. coherency-Info.

Examples for Option 1 and Option 2 are shown in FIG. 17 and FIG. 16, respectively, where QCL-Type A, B, C, D can be the same as defined in 5G specification (38.214), or they can be different, and Type E corresponds to coherency.

A measurement and reporting to enable multivariate TCI state indication can be supported. Such reporting can be aperiodic: either NW-controlled (via DCI either UL-DCI or DL-DCI or a dedicated DCI, including two-stage DCI) or UE-initiated (e.g. UCI either PUCCH or PUSCH or dedicated layer 1 UL channel, including two-stage UCI). The UE-initiated can be based on an event detection.

As mentioned below, the inter-PG mobility can be used to update a candidate set of PGs in order to maintain seamless “cell-free” access to RRC-connected UEs.

Akin to NR UL codebook, the Coherency between/within PGs can be (1) full-coherence (FC), i.e., a layer (stream) is transmitted using all antenna ports, (2) partial-coherence (PC), i.e., a layer (stream) is transmitted using at least two but not all antenna ports, or (3) non-coherence (NC), i.e., a layer (stream) is transmitted using one antenna port.

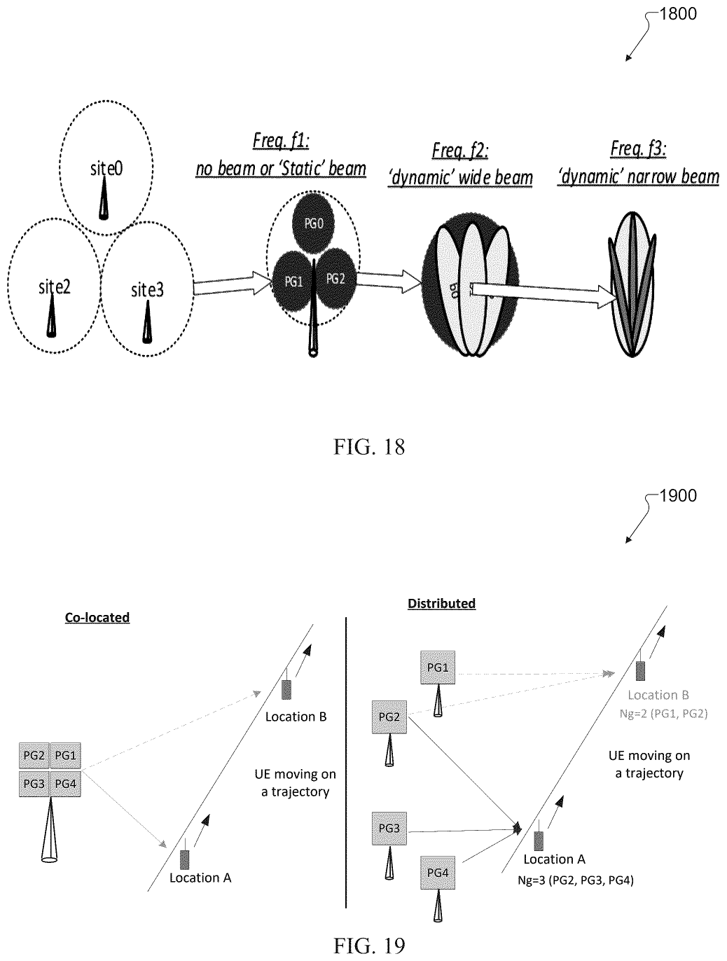

FIG. 18 illustrates a diagram of an example analog beam-based network 1800 according to embodiments of the present disclosure. For example, the network 1800 may be implemented in the network 100 in FIG. 1. This example is for illustration only and other embodiments can be used without departing from the scope of the present disclosure.

FIG. 19 illustrates examples of a UE moving on a trajectory located in co-located and distributed PGs 1900 according to embodiments of the present disclosure. The examples depicted in FIG. 19 may be implemented in a network, such as, the network 100 in FIG. 1. These example is for illustration only and other embodiments can be used without departing from the scope of the present disclosure.

In one embodiment, a cellular region can be served by partitioning (or covering) the region into (with) multiple sites and deploying multiple PGs at each site. An example is illustrated in FIG. 18 wherein there are three PGs per site. For a frequency f1 (e.g. FR1), each PG is controlled by a fully-digital processing chain, implying there is no analog beam or a fixed beam, and all PGs at one site together can serve users belonging to the respective site. At a higher frequency f2 (e.g. FR2), each PG is associated with a hybrid analog-digital structure, implying each antenna port of the PG needs to be assigned/updated with one of the three wide beams. At an even higher frequency, since analog beams get narrower (reduced beam-width), number of analog beams increases, hence antenna ports of an PG need to be assigned/updated with one of the nine narrow beams. In general, a PG can be assigned/updated with A_{g} analog beams. When A_{g}=1, there is one analog beam per PG. When A_{g}=Nₚₐₙₑₗ, there is one analog beam per antenna panel/port per PG. In a mobility scenario, multiple PGs can serve a moving user. An illustration is shown in FIG. 19. While the user moves from a location A to another location B, the set of PGs is updated from {PG2, PG3, PG4} to {PG1, PG2}. Consequently, a seamless beam-based (as opposed to cell-based) mobility is possible especially for RRC-connected UEs.

An example of parameters relevant for PGs are tabulated in TABLE 2. Depending on carrier frequency, BF, and NW topology, the user can be configured with N_{g} PGs and values of relevant parameters.

TABLE 2

| | Values | |
|---|---|---|
| Parameters | Fully-digital | Hybrid BF |
| Number of PGs, N_{g} | {1, 2, 3, 4} | Nₚₐₙₑₗ ∈ {1, 2, 4} |
| Number of ports per PG, P_{g} | {1, 2, 4, . . . , | 1 |
| | 256} | |
| Number of beams per port, | 1 | 1 ≤ n_{b} ≤ 256 |
| N_{b} | | |
| Port assignment/update | Semi-static (fixed) | Dynamic |
| FD granularity | T-F patterns, repeats | WB |
| TD granularity | across RBs | Multiple symbols (one |
| | | per beam) |
| Density | {0.5, 1} | {1, 3} |
| Measurement | One-shot: AP | Beam-sweeping |
| | Multi-shot: P/SP | (symbol-level) |

In one example, for antenna ports within an PG, LT channel properties (QCL and coherency) remain the same, and for antenna ports across PGs, LT channel properties (QCL and coherency) can be different. In one example, for antenna ports within an PG or across PGs, LT channel properties (QCL and coherency) can be same or different.

The DCI payload size for indicating a multivariate TCI state can be large (due to multiple variables associated with properties). If a single DCI is used for indicating this multivariate TCI state, this will result in a large number of DCI decoding hypotheses, an issue for UE power consumption. Besides, the UE would need to buffer the control channel carrying DCI bit before decoding, adding further to the UE power consumption. It is therefore essential to design more efficient layer 1 control signalling. One such design can be based on a dual-/two-stage DCI.

In one embodiment, a dual-stage control (DCI) can also be used/configured/indicated for the NW-controlled PG selection, and the indication of the multivariate TCI state, especially when the number of activated TCI states is large (e.g. multi-beam MIMO, inter-cell multi-beam operations, coherent transmission etc.), including a fixed first stage payload size that indicates the information size and content of the second stage. For instance, for the NW-controlled PG selection,
DCI part 1 includes a first information about the PG selection hypothesis, and size (payload) of the second stage DCI
DCI part 2 includes a second information based on the first information

Two examples can be as follows.
Ex1: (1st information, 2nd information)=(number of PG selection hypotheses, indices of selected PGs)
Ex2: (1st information, 2nd information)=(a set of PGs, properties of the selected PGs)

In one embodiment, a UE can be configured with the PG-based framework to support advanced features such as NW energy saving (NES), dynamic port assignment (ON/OFF) for FR2, and MIMO for Duplex. In particular, these features can be based on the multivariate TCI state definition, e.g. via different PG selection hypotheses.

In one embodiment, in mobility scenarios, to provide seamless (un-interrupted) service to a RRC-connected UE, the above MIMO framework can include a dynamic (layer 1)-based update of PG(s) for the UE, this update can be based measurement/reporting of PG(s) from a set of configured/activated candidate PG(s), akin to the beam measurement/reporting and TCI state indication in NR.

In one embodiment, a UE is configured (e.g. via higher layer) with a measurement procedure that includes information.
Component (C1): a number of ports Nₚₒᵣₜ
Component (C2): a set of T-F resources (REs) S, e.g. S is a pattern (from multiple patterns)
Component (C3): a mapping between C1 and C2 including
   (C3-1): density d=number of REs per PRB per port, e.g. 0.5, 1, 3; when d=0.5, a port is measured via an RE in even-numbered or odd-numbered PRBs, when d=1, a port is measured via an RE in each PRB; when d=3, a port is measured via 3 REs in each PRB, and so on.
   (C3-2): when Nₚₒᵣₜ>1, each port pᵢ is assigned a subset of RES Sᵢ, where i∈{0, . . . , Nₚₒᵣₜ-1} or ∈{1, . . . , Nₚₒᵣₜ}, where the value pᵢ=X+i and X=port number of the first of the Nₚₒᵣₜ ports.

In one embodiment, a UE is configured (e.g. via higher layer) with a measurement region/entity which is associated with Z≥1 RSs. For example, each RS can be NZP CSI-RS, ZP CSI-RS, SSB, a new DL RS, DL DMRS, path-loss-RS (PL-RS), positioning RS (PRS), or PTRS or TRS. The slot or slot offset (w.r.t. to a reference slot such as the slot in which corresponding DCI is received/decoded) for measuring the Z RSs can be fixed, or configured (RRC), or indicated via MAC CE or DCI.

In one example, the measurement region/entity is within a time slot (e.g. DL slot).
In one example, the RS can only be (A1) aperiodic (AP), i.e. triggered via DCI field (e.g. CSI request field in a DCI).
In one example, the RS can be (A2) AP with repetition ON/OFF. When repetition is ON, the RS can be measured over a number of repetitions in time domain (e.g. consecutive slots, or slots separated by a m slots). The information about the repetition can be configured via higher layer or indicated via the MAC CE or/and DCI.
In one example, the RS can be (A3) AP and multi-shot, wherein the RS can be measured with a periodicity (p) starting from a slot depending on the slot offset. The value of p can be fixed, configured (via RRC) or indicated via DCI.
In one example, the RS can be measured (A4) via a slot associated with a semi-persistent (SP) measurement entity with respect to a slot depending on the slot offset. The slot can be a first slot or a last slot or a configured slot from the set of slots associated with the SP measurement entity.
AP or SP or P (the 1st slot with SP resource, or the last slot with SP resource or the slot is configured, indicated via DCI, e.g. based in an offset).
In one example, the RS can either be A1 or A2.
In one example, the RS can either be A1 or A3.
In one example, the RS can either be A1 or A4.
In one example, the RS can either be A1 or A2 or A3.
In one example, the RS can either be A1 or A2 or A4.
In one example, the RS can either be Al or A3 or A4.
In one example, the RS can either be A2 or A3 or A4.
In one example, the RS can either be A1 or A2 or A3 or A4.

In one example, the measurement region/entity can be within a time interval comprising K slots separated by m slots. The value of m can be fixed, e.g. m=1 (consecutive slots). The information about or the value of m can be configured via higher layer or indicated via the MAC CE or/and DCI. In one example, the Z RSs corresponds to a burst or window of measurement slots.

In one example, the measurement region/entity can be within a set of time slots, where the set of slots can be configured via higher layer or indicated via the MAC CE or/and DCI.

In one example, the measurement region/entity can be configured for one or multiple of the following purpose or use cases.
In one example, the measurement region/entity can only be configured for channel measurement (CMR).

In one example, the measurement region/entity can only be configured for interference measurement (IMR).
In one example, the measurement region/entity can be CMR or IMR, but not both based on a configuration (RRC) or a dynamic signaling (MAC CE or DCI).
In one example, the measurement region/entity can be associated with a set of N_{port,CMR} ports (or PG(s)) configured/indicated as CMR or/and a set of N_{port,IMR} ports (or PG(s)) configured/indicated as IMR, where N_{port,CMR}+N_{port,IMR}=Nₚₒᵣₜ.
   In one example, N_{port,IMR}=1.
   In one example, a bitmap (b₀ . . . b_{N}_{ₚₒᵣₜ}₋₁ or b_{N}_{ₚₒᵣₜ}₋₁ . . . b₀ or b₁ . . . b_{N}_{ₚₒᵣₜ} or b_{N}_{ₚₒᵣₜ} . . . b₁) of length Nₚₒᵣₜ bits is used to indicate the assignment of ports as CMR or IMR. For instance, when a bit value=0, the corresponding port is a CMR port, and when a bit value=1, the corresponding port is a IMR port. Or, when a bit value=1, the corresponding port is a CMR port, and when a bit value=0, the corresponding port is a IMR port.
In one example, a 1-bit signaling or a parameter or a code point is used to indicate one of the two options.
   In one example, the two options are CMR and IMR.
   In one example, the two options are according to one or more examples described herein.
In one example, a Y-bit signaling or a parameter or a code point is used to indicate one of the four examples above.

In one example, at least one of the following examples is used/configured for the value of Nₚₒᵣₜ.
In one example, the UE can be dynamically indicated with a value of Nₚₒᵣₜ via MAC CE o DCI.
In one example, an initial value of Nₚₒᵣₜ can be fixed or configured, but this value can be changed dynamically via MAC CE or DCI.
In one example, multiple candidate values for Nₚₒᵣₜ are configured (RRC), and one of them is indicated via MAC CE or/and DCI as the value of Nₚₒᵣₜ for the measurement.

In one example, at least one of the following examples is used/configured for a value of power or power offset associated with the RS or port or PG(s).
In one example, the UE can be dynamically indicated with a value power offset via MAC CE o DCI. In one example, this value is the same/common for all Nₚₒᵣₜ ports. In one example, this value is indicated for each of the all Nₚₒᵣₜ ports.
In one example, an initial value of power offset can be fixed or configured, but this value can be changed dynamically via MAC CE or DCI.
In one example, multiple candidate values for power offset are configured (RRC), and one of them is indicated via MAC CE or/and DCI as the value of power offset for the measurement

In one example, at least one of the following examples is used/configured regarding a number of CSI-RS ports (value of N_{CSI-RS}) associated with a CSI reporting (e.g. that is triggered via a DCI field indication the corresponding CSI-Trigger-State that can be configured via higher layer).
In one example, the number of CSI-RS ports can be changed based on the number of PGs (the value of N_{g}) dynamically (e.g. via MAC CE or/and DCI). For example, N_{CSI-RS}=N_{g}Nₚₒᵣₜ. Or.

$${N}_{CS 1 - RS} = \frac{{N}_{port}}{{N}_{g}} .$$

In one example, the number of CSI-RS ports can be changed based on the number of ports associated with at least one PG r (the value of P_{CSIRS.r}). For example, N_{CSI-RS,r}=N_{g}Nₚₒᵣₜ. Or

$${N}_{CS 1 - RS . r} = \frac{{N}_{port}}{{N}_{g}} .$$

In one example, when N_{g}>1 PGs,
   In one example, the number of CSI-RS ports for CSI reporting can be indicated for each PG separately. There are N_{g} or N_{g}-1 (when the last value of Nₚₒᵣₜ minus sum of all indicated values) values indicated.
   In one example, the number of CSI-RS ports for CSI reporting can be indicated across all PGs. In one example, Nₚₒᵣₜ=indicated value. In one example, the indicated value is distributed across PGs based on a fixed mapping or configured mapping.

One use case of this feature can be enabling faster measurement of different number of ports, or network energy saving or switching from a set of PGs to another set of PGs (seamless/RRC-connected mobility).

In one example, for a given measurement region/entity (as described above), configured via RRC, the number of SD measurement unit (e.g. CSI-RS ports) can be assigned dynamically via DCI or/and MAC CE, for example, from 16 ports to 32 ports or vice versa.
In one example, a higher layer or/and MAC CE can indicate multiple candidates for the number of SD units (e.g. CSI-RS ports), and a DCI can indicate one of the multiple candidate values.
In one example, a higher layer can indicate multiple candidates for the number of SD units (e.g. CSI-RS ports), and a MAC CE or/and a DCI can indicate one of the multiple candidate values.
In one example, the value of Nₚₒᵣₜ and the mapping of port indices to the measurement region (i.e. C1 and C3 according to one or more embodiments described herein) can be indicated dynamically via MAC CE or/and DCI.
   In one example, there are multiple candidate patterns for each candidate value of Nₚₒᵣₜ, and the UE is configured with one pattern (from the candidates) and one value of Nₚₒᵣₜ (from the candidates) dynamically.
   In one example, the indication is completely dynamic. For example, any port can be assigned any candidate RE either within a PRB or across multiple PRBs.
   In one example, when the measurement region is uniform in time and frequency (i.e. candidate measurement REs form a uniform pattern within a PRB or across multiple PRBs), the port assignment can also be uniform (e.g. uniformly multiplexed) starting at an RE and following a route or pattern.

In one example, a UE can be configured with an AP CSI trigger state (via higher layer) for the CSI reporting associated with the measurement region (as described above), where the CSI reporting is based on two UL (e.g. PUSCH) slots (e.g. consecutive or separated). This can be beneficial when the CSI overhead is so large that it is needed to partition UCI carrying the CSI into 4 parts (two-part UCI, in each of the two slots).

In one example, the value of Nₚₒᵣₜ can be a number, including or excluding one or more values supported in NR (i.e. 1, 2, 4, 8, 12, 16, 24, 32). For instance, it can be an odd value (e.g. 3, 5, 6, 7, . . . ).
In one example, the value can be 1 or an even number {2, 4, . . . , M} where M is max value (e.g. 32, 64, 128, 256).
In one example, the value can be from {1,2} or {1,2,3} or a number which is a multiple of 4, i.e., {4, 8, . . . , M} where M is max value (e.g. 32, 64, 128, 256).
In one example, the value can be from {1, 2, 4} or {1, 2, 3, 4} or {1, 2, 4, 6}, or {1, 2, 3, 4, 6} or {1, 2, . . . , 7} or a number which is a multiple of 8, i.e., {8, 16, . . . , M} where M is max value (e.g. 32, 64, 128, 256).
In one example, the value can be from {1, 2, 4} or {1, 2, 3, 4} or {1, 2, 4, 6}, or {1, 2, 3, 4, 6} or {1, 2, . . . , 15} or a number which is a multiple of 16, i.e., {16, 32, . . . , M} where M is max value (e.g. 64, 128, 256).
In one example, the value can be from {1, 2, 4} or {1, 2, 3, 4} or {1, 2, 4, 6}, or {1, 2, 3, 4, 6} or {1, 2, . . . ,31} or a number which is a multiple of 32, i.e., {32, 64, . . . , M} where M is max value (e.g. 64, 128, 256).
In one example, a number of ports in a PG can be fixed/configured to one, and hence Nₚₒᵣₜ=N_{g}. In one example, the value of N_{g} can be configured (RRC) or dynamically (MACE CE or/and DCI) from a set of candidate values. The candidate values can belong to {1, 2, 3, 4}, or {1, 2, . . . , 8}, or {1, 2, . . . , M} and the value M can be from {4, . . . , 64} or {4, . . . , 128} or {4, . . . , 256}.

In one example, the DCI used to indicated/trigger the measurement entity/region itself of a parameter/components associated with it (as described above) can be according to one of the following examples.
In one example, the DCI is DL-related DCI (with or without DL PDSCH assignment) or a dedicated DL DCI.
In one example, the DCI is UL-related DCI (with or without UL PUSCH grant) or a dedicated UL DCI.
In one example, the DCI is a multivariate TCI comprising several variables.
In one example, the DCI is two-stage DCI with stage 1 DCI having a small, fixed payload size, and indicating the size of the stage 2 DCI. Both stages of the DCI are in the same slot.
In one example, the DCI is two-stage multivariate DCI with stage 1 multivariate DCI having a small, fixed payload size, and indicating the size of the stage 2 DCI. Both stages of the DCI are in the same slot.

In one example, a UE is indicated with an indication (code point or DCI field) including a value of Nₚₒᵣₜ via a DCI-common (which can be a UE-group-common DCI common for multiple UEs), and the indication assigns Nₚₒᵣₜ to the configured measurement entity. The UE can then be triggered with an AP CSI report that is associated with the measurement region. This trigger can be from the NW (e.g. via a DCI, same or different from the DCI-common). Or the UE can itself trigger a UE-initiated CSI reporting (e.g. based on an event detection).

In one example,
In one example, when number of ports is reduced (e.g. halved) via dynamic indication, the set of candidate REs also reduces (by the same or different fraction/amount), and vice versa.
In one example, the set of candidate REs remains the same regardless of whether number of ports is changes via dynamic indication.

In one embodiment, a UE receives a configuration (e.g. CSI-RS-Config) including one of the following:
In one example, a list of CSI Trigger States, and MAC-CE or/and DCI triggers one
In one example, a list of CSI Trigger States, each may include an ID or a list of multiple sub-configurations; and MAC-CE or/and DCI triggers one
   In one example, 1 CSI Trigger State
   In one example, 1 CSI Trigger State and one or multiple sub-configurations within that CSI Trigger State
      MAC CE activates 1 Trigger State; and DCI indicates one or multiple sub-configs
   In one example, >1 CSI Trigger State and one or multiple sub-configurations within each CSI Trigger State
      MAC CE activates 1 Trigger State; and DCI indicates one or multiple sub-configs
In one example, multiple configurations (e.g. CSI Trigger States)
   MAC CE or/and DCI triggers one Trigger State

In one embodiment, a UE receives a configuration (e.g. CSI-RS-Config), where (FD, TD) higher layer configured

(as described above) and SD (ports or PGs) via MAC CE or DCI (as described above)
In one example, Pattern repeat in each PRB or across multiple PRBs
In one example, Multiple PRBs can on consecutive
In one example, Multiple can be comb-like uniformly separated
In one example, there is no pattern, a rule is used instead

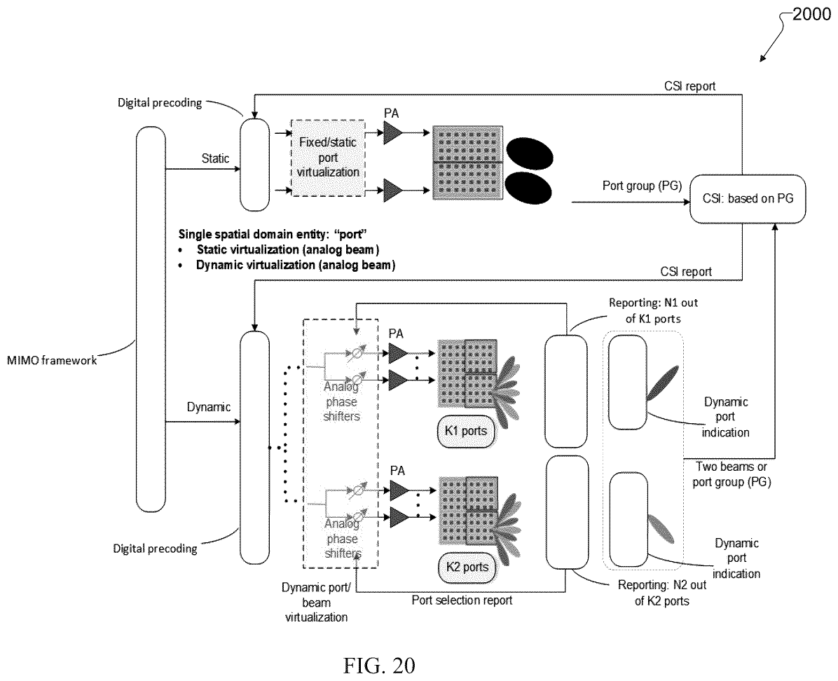

FIG. 20 illustrates a diagram of an example downlink (DL) channel state information (CSI) acquisition architecture 2000 according to embodiments of the present disclosure. For example, the architecture 2000 may be implemented in a base station, such as, the BS 102 in FIG. 1. This example is for illustration only and other embodiments can be used without departing from the scope of the present disclosure.

For the purpose of DL CSI acquisition, when necessary, a port group (PG) can be defined as a collection of N_{b}≥1 ports sharing a commonly configured set of properties (analogous to CSI-RS resource in 5G NR). This is instrumental in CSI reporting utilized for mTRP or multiple O-RUs (especially CJT) or virtual sectorization where a TRP or a O-RU or a virtual sector corresponds to a PG. Three key components of the framework are shown in FIG. 20.
C1: measurement and reporting to facilitate port selection/indication,
C2: dynamic indication of N port(s) out of K ports, and
C3: CSI reporting to enable digital precoding across a UE-recommended port group (PG).

In FR2 (i.e. in case of dynamic virtualization via analog beam), C1-C3 are utilized, and in FR1/FR3 (i.e., in case of fixed virtualization), only C3 is utilized. In the following, a PG is defined for FR1/FR3 (fixed virtualization case), not for FR2. In one example, PG is defined regardless of frequency band. An example FR1-FR3 are shown in TABLE 3.

TABLE 3

| Frequency range | Band |
|---|---|
| FR1 | Low band (<1 GHz) |
| FR1/FR3 | Lower mid band (1~7 GHz) |
| FR3 | Upper mid band (7~24) |
| FR2 | mmWave (>24 GHz) |

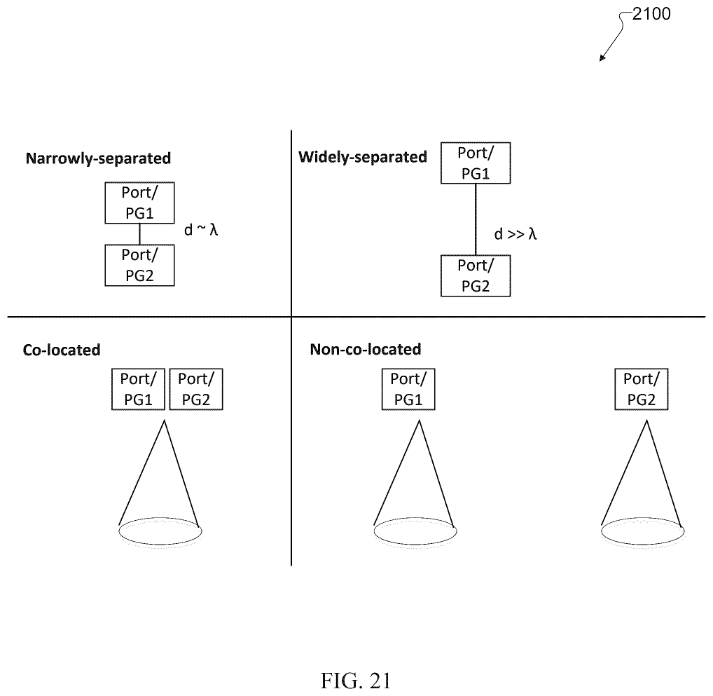

FIG. 21 illustrates a diagram of example co-located and non-co-located ports 2100 according to embodiments of the present disclosure. For example, the co-located and non-co-located ports 2100 may be implemented by base stations or TRPs in a network, such as, the network 100 in FIG. 1. This example is for illustration only and other embodiments can be used without departing from the scope of the present disclosure.

In one embodiment, a UE is configured with a CSI report (e.g. trigger state or a CSI report setting via higher layer IE CSI-AperiodicTriggerState or CSI-ReportConfig) based on a port-based/PG-based framework, wherein the CSI report is based on a measurement configuration (e.g. CSI-ResourceConfig or CSI-MeasurementConfig or CSI-PGConfig or CSI-PortConfig).

The measurement configuration includes a configuration for channel measurement, which can be according to one of the following examples.
In one example, the channel measurement corresponds to measuring P_{CSIRS} CSI-RS ports.
In one example, the channel measurement corresponds to measuring N_{g}≥1 PGs, where a PG g=1 . . . , N_{g} includes P_{CSIRS,r} CSI-RS ports.
In one example, the channel measurement corresponds to measuring the Q_{CSIRS} ports or M_{g} PGs indicated dynamically (E.g. via DCI or/and MAC CE), where the Q_{CSIRS} ports or M_{g} PGs respectively are from the configured the P_{CSIRS} ports or N_{g} PGs. The dynamic indication can facilitate turning ports or PGs ON/OFF (e.g. for energy saving purpose).

As shown in FIG. 21, the ports/PGs can be narrowly-spaced or widely-spaced with compared with the wavelength λ of the (center) carrier of the frequency band associated with the CSI report. Or the ports/PGs can be col-located (at physical location) or non-co-located (at different physical locations).

The measurement configuration can also include a configuration for interference measurement.
In one example, the interference measurement corresponds to measuring I_{IMR} CSI-IMR ports. In one example, I_{IMR}=P_{CSIRS}. In one example, I_{IMR}=1.
In one example, the interference measurement corresponds to measuring I_{g}≥1 PGs, where a PGr=1 . . . , I_{g} includes I_{IMR,r} CSI-IMR ports. In one example, I_{g}=N_{g}. In one example, I_{g}=1. In one example, I_{IMR,r}=P_{CSIRS,r}. In one example, I_{IMR,r}=1.

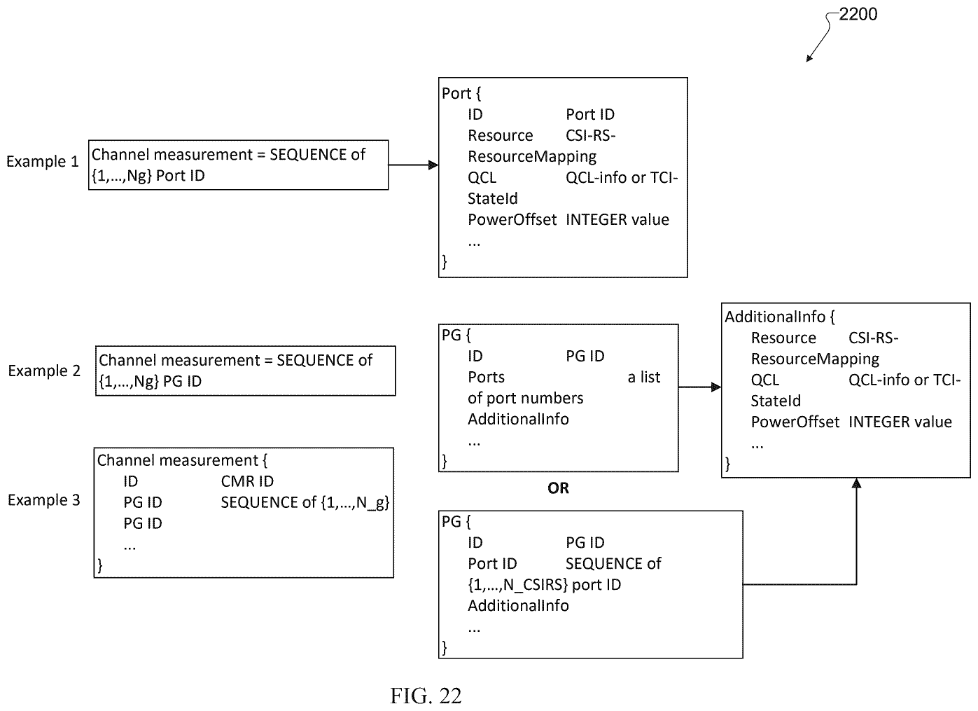

FIG. 22 illustrates a diagram of example channel measurement configurations 2200 according to embodiments of the present disclosure. For example, the configurations 2200 may be utilized by a UE, such as, the UE 116 in FIG. 1. This example is for illustration only and other embodiments can be used without departing from the scope of the present disclosure.

In one example, a configuration for channel measurement includes at least one of the following:
In one example, a configuration for channel measurement includes a list (or sequence) of port IDs, where a port ID indicates an information (e.g. IE) about a port for measurement. Example 1 in FIG. 22 is an example.
In one example, a configuration for channel measurement includes an ID of a PG (e.g. PG ID) or a sequence of N_{g}≥1 IDs (e.g. each is a PG ID). Example 2 and 3 in FIG. 22 are two examples.
In one example, a configuration for channel measurement includes a list of port numbers (e.g. for CSI-RS, port numbers are from {3000, 3001, 3002, . . . }).

In one example, the UE receives a trigger message (e.g. which indicates a CSI-TriggerState) for aperiodic (AP) reporting of the CSI report. In one example, the trigger message is received via a DCI (e.g. CSI request field in an UL-related DCI or a CSI request field in a DL-related DCI or a CSI request field in a dedicated or special purpose DCI that is different from DL-related DCI or UL-related DCI). Here, DCI-related DCI corresponds to a DCI (format) that allocates DL PDSCH assignment, and UL-related DCI corresponds to a DCI (format) that grants UL PUSCH transmission.

In one example, the UE initiates/triggers the measurement/reporting by transmitting a message/request to the NW. The message/request acts as a trigger (e.g. which indicates a CSI-TriggerState) for the AP reporting of the CSI report. In one example, the message/request is via a layer 1 signaling such as scheduling request (SR) or UCI. In this example, higher layer RRC (or/and MAC CE) is used to configure (and activate) one or more than one AP CSI trigger states, and SR/UCI with the message/request acts as a trigger (without any indication from NW). The UL resource allocation (RA) for CSI report can be pre-configured (CG PUSCH), or granted after the UE-initiated trigger/request is received.

In one example, the UE initiates/triggers the measurement/reporting by transmitting a message/request to the NW. The message/request acts as a trigger (e.g. which indicates a CSI-TriggerState) for the AP reporting of the CSI report. The UE then receives an ACK (e.g. 1-bit in DCI), and then performs measurement and reporting of the CSI report. In one example, the message/request is via a layer 1 signaling such as scheduling request (SR) or UCI. In this example, higher layer RRC (or/and MAC CE) is used to configure (and activate) one or more than one AP CSI trigger states, and SR/UCI with the message/request acts as a trigger or activator and the ACK from the NW allows/initiates the CSI reporting procedure. The UL resource allocation (RA) for CSI report can be pre-configured (CG PUSCH), or granted (e.g. together with ACK).

In a variation of the previous example, a first DCI (as explained above) can dynamically change/adapt information about the measurement (e.g. number of ports, power level etc.) associated with the CSI report, but does not trigger the CSI report. The trigger is UE-initiated. The NW can ACK in response to the UE-initiated trigger/request via a second DCI, and then the UE measures and reports the CSI report according to the latest update (if any) of the CSI Trigger state (via the first DCI). In one example, the first DCI and the second DCI are the same. In one example, they can be different.

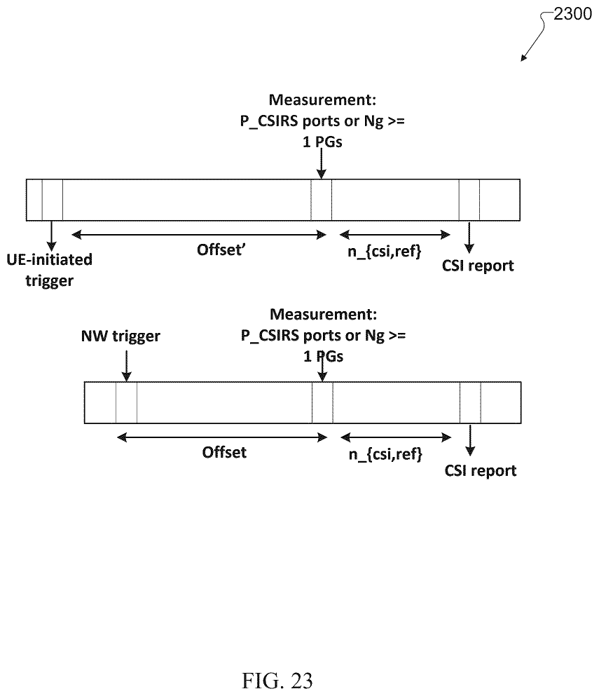

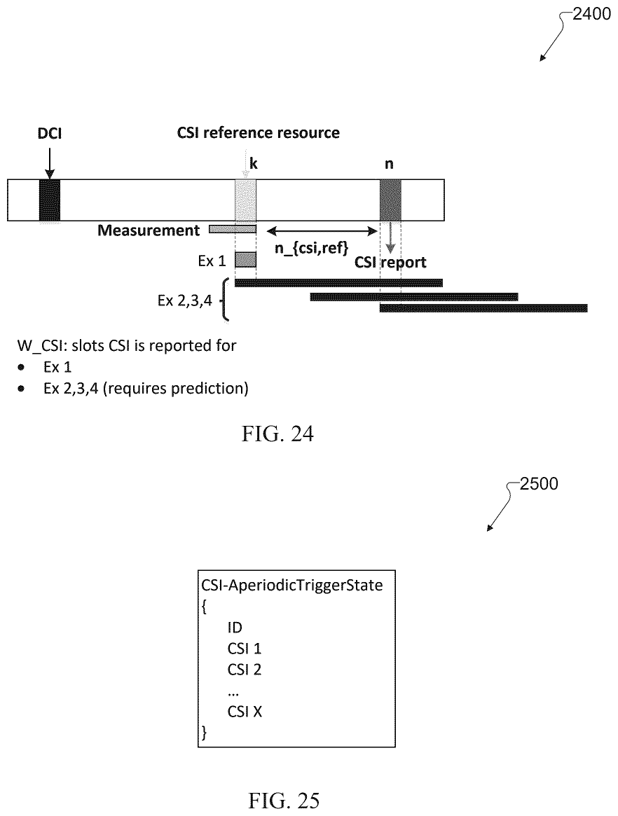

FIG. 23 illustrates a diagram of an example CSI report trigger 2300 according to embodiments of the present disclosure. FIG. 24 illustrates a diagram of an example CSI reference (resource) slot 2400 according to embodiments of the present disclosure. For example, the CSI report trigger 2300 and CSI reference (resource) slot 2400 may be utilized by a UE, such as, the UE 116 in FIG. 1. These example is for illustration only and other embodiments can be used without departing from the scope of the present disclosure.

With reference to FIG. 23, a NW-triggered and UE-initiated CSI report is shown. The trigger is shown in black. After a time duration (Offset' or Offset) from the slot with the trigger, UE receives the measurement (ports or PGs), and then calculates the CSI report for reporting in a slot that is n_{csi,ref} slots after the last measurement slot (aka CSI reference resource slot).

In one example, if the UE is capable to perform CSI prediction, the CSI report is expected to be valid for a CSI reporting window [l, . . . l+W_{CSI}-1], where l is a first time slot of the CSI reporting window, and W_{CSI} is a total number of time slots the CSI report is valid for. This is illustrated in FIG. 24, where n is a slot number (index) of the CSI report, and k is a slot number (index) of the CSI reference (resource) slot. The CSI reference (resource) slot is the (last) slot for the measurement. A slot after this slot has no measurement, hence, the UE needs to perform prediction if such a slot is included in the CSI reporting window.
In one example, W_{CSI}=1 and l=n−n_{csi,ref}=k. This is shown as Ex 1 in the figure.
In one example, W_{CSI}>1 (e.g. 2, 3, 4). Three examples (Ex 2, 3, 4) are shown in the figure depending on the value of l. In one example, l=k. In one example, k<l<n. In one example, n=l. In one example, n<l.

In one example, the measurement is a single slot measurement (e.g. when AP CSI-RS measurement), which is before (earlier than) or up to the CSI reference slot.

In one example, the measurement is a multi-slot measurement (e.g. a group of K>1 AP CSI-RSs, or an AP CSI-RS with repetition ON, where the repetition K is configured or fixed or dynamically indicated via DCI, or a SP CSI-RS), which are before (earlier than) or up to the CSI reference slot.

In one example, the UE is configured with a semi-persistent (SP) measurement and reporting of the CSI report, wherein the CSI report is reported periodically within a time window. The start (first slot) of the time window is determined based on the trigger and the number K of CSI reports and the periodicity P (separation in slot) between two consecutive CSI reports is either fixed, or configured (via the CSI-TriggerState, or a separate higher layer signaling), or indicated dynamically via the DCI that triggers the CSI report. Likewise, the last slot (or last CSI report within the time window) can be fixed, or configured (via the CSI-TriggerState, or a separate higher layer signaling), or indicated dynamically via the DCI that triggers the CSI report.

In one example, when K=1, the CSI report is AP CSI, and when K>1, the CSI report is SP CSI.

In one example, when the CSI report is PMI-based (i.e. CSI report include PMI), the measurement and report of the CSI report can only be AP (or SP), i.e., the measurement and reporting cannot be a periodic (P) P-CSI-RS and P-CSI reporting (this is for efficient NW resource utilization since P CSI requires RRC-level signaling).

In one example, when the CSI report is not PMI-based (i.e. the CSI report does not include PMI), the measurement and report of the CSI report can periodic (in addition to AP or SP).

In one example, there is no restriction on the measurement RS, i.e. it can be P, AP, or SP, however, the CSI report can only be AP (or SP).

Note that DL RS for other purpose (than CSI) such as TRS, PL-RS, positioning RS (PRS), PTRS may not be associated with (or considered as measurement RS for) PMI-based CSI. Hence, they may be configured to the UE for purposes other than PMI-based CSI.

In one example, the CSI report corresponds to at least one of the following hypotheses/use cases.
In one example, the CSI report corresponds a NCJT hypothesis across P_{CSIRS} ports or N_{g} PGs, i.e., a (precoder) layer is transmitted via one port or PG.
In one example, the CSI report corresponds a CJT hypothesis across P_{CSIRS} ports N_{g} or PGs, i.e., a (precoder) layer is transmitted via (coherently combining) multiple ports or PGs.
In one example, the CSI report corresponds a dynamic point selection (DPS) hypothesis across P_{CSIRS} ports or N_{g} PGs, i.e., a subset of ports or PGs is selected (dynamically by the UE), and the CSI report corresponds to the selected subset of ports or PGs. The information about the selection is also reported by the UE, e.g. as part of the CSI report (i.e., an indicator).
In one example, the CSI report corresponds to all P_{CSIRS} ports or N_{g} PG(s).
In one example, the CSI report corresponds to a duplex operation, wherein the NW can perform DL transmission and UL reception simultaneously (for a given carrier) in a slot. The CSI report in this case can correspond to two CSIs, one CSI for the non-Duplex MIMO operation, and another CSI for the Duplex MIMO operation.
In one example, the CSI report corresponds to NW energy saving (NES) operation, wherein the NW can turn OFF/ON a subset of ports or PGs dynamically. The CSI report in this case can correspond to two CSIs, one CSI for the non-NES MIMO operation (when none of ports/PGs are turned OFF), and another CSI for the NES MIMO operation (when a subset of ports/PGs are turned OFF). Or the CSI report corresponds to the port/PGs that are turned ON. The information about ports/PGs that are turned ON can be provide dynamically (e.g. via DCI).

In one example, the UE is configured with at least one hypothesis for the CSI report. This can be a part of (included in) the CSI-TriggerState or can be provided/indicated via the TCI state indication (e.g. a bitmap or combinatorial indicator or a list of ports/PGs can be included in the TCI state definition or signaling associated with the TCI state).

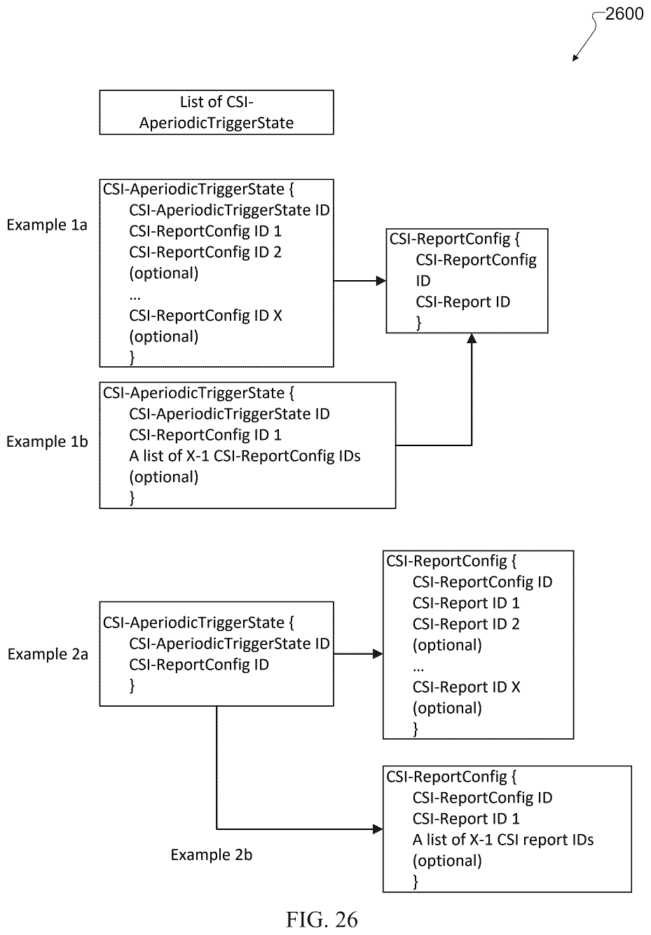

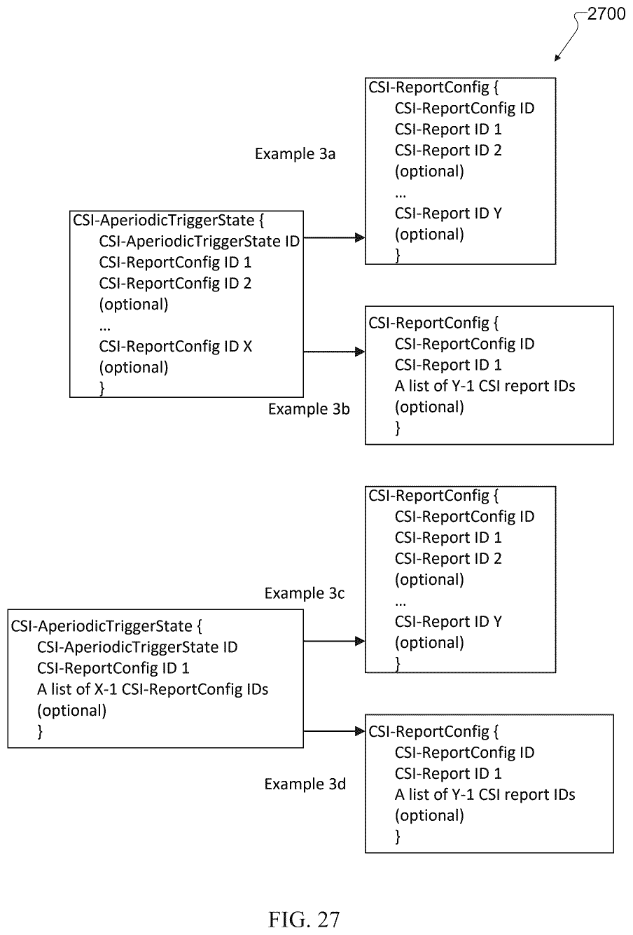

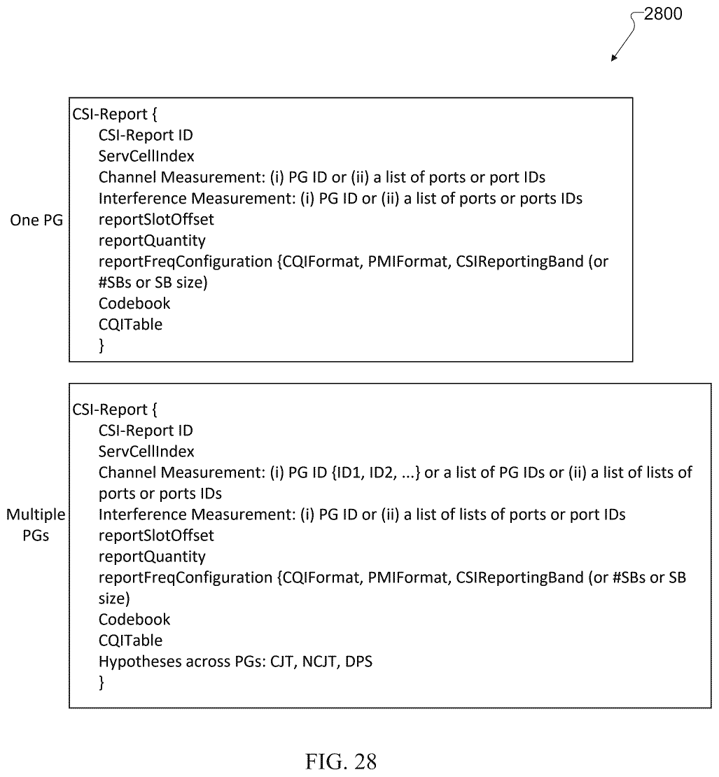

FIG. 25 illustrates a diagram of an example trigger state 2500 according to embodiments of the present disclosure. FIG. 26 illustrates a diagram of example trigger states 2600 according to embodiments of the present disclosure. FIG. 27 illustrates a diagram of example trigger states 2700 according to embodiments of the present disclosure. FIG. 28 illustrates a diagram of example trigger states 2800 according to embodiments of the present disclosure. For example, the trigger states 2500-2800 may be utilized by a UE, such as, the UE 116 in FIG. 1. These examples are for illustration only and other embodiments can be used without departing from the scope of the present disclosure.

In one embodiment, the UE is configured with a list of trigger states, including at least one CSI trigger state, via a higher layer IE (e.g. CSI-AperiodicTriggerState) for the CSI report, as described earlier in this disclosure, wherein the trigger state includes an ID and up to X CSI where X≥1. This is shown in FIG. 25. The value X=1 is mandatory (single CSI). The value X=2 implies that there are two CSIs (CSI 1 and CSI 2).
In one example, the CSIs are two separate/independent CSIs. In this case, two CSIs can correspond two hypotheses about the CSI. For instance, for duplex operation, CSI 1 can be for non-duplex and CSI 2 can be for duplex. Likewise, CSI 1 can be for non-energy saving and CSI 2 can be for energy saving (a subset of ports are turned OFF, hence can't be measured/assumed for the CSI report).
In one example, the CSIs are two parts of a CSI (with two parts).
In one example, the CSIs are two inter-dependent CSIs. For example, CSI2 may be dependent on CSI1.

In one embodiment, the UE is configured with a list of CSI trigger states, including at least one CSI trigger state, via a higher layer IE (e.g. CSI-AperiodicTriggerState) for the CSI report, as described earlier in this disclosure, wherein the CSI trigger state includes an trigger state ID and up to X CSI report IDs where X≥1. The value X=1 is mandatory (single CSI report) and corresponds to a mandatory IE (ID of a CSI report). When X>1, there are X-1 additional IEs for additional CSI reports. These additional CSI reports are optional. The value X can be fixed or configured via higher layer. In one example, the value of X is variable and requires dynamic indication. Such an indication can be via a DCI, where the DCI can be a one-stage DCI or two-stage DCI. When two-stage, the first stage can provide a value of X and the second stage provides the indices of the corresponding IEs. This DCI can be a DL-related DCI (i.e. a DCI formal with DL assignment), or a UL-related DCI (e.g. a DCI formal with UL grant) or a dedicated special purpose DCI. In one example, a bitmap of length X or X-1 bits is indicated to indicate X′ CSI reports (or their IEs or IDs) out of X or X-1 CSI reports that can be triggered via the corresponding CSI trigger state.

In one example, X CSI reports correspond to X hypotheses. Two examples in FIG. 26. In Example 1, the trigger state includes the IDs of CSI report config, and each config corresponds to a CSI report. In Example 2, the trigger state includes the ID of CSI report config, which includes IDs of X CSI reports. Each CSI report ID indicates an IE for the CSI report, which includes information about the CSI report. Two examples are shown in FIG. 28.

In general, a CSI trigger state can be according to a combination of Example 1 and Example 2. Four examples of such a combination are shown in FIG. 27.

In one example, for one PG (or O-RU), i.e., for intra-PG or intra-O-RU case, ID 1 through ID X correspond to multiple hypotheses.
In one example (NES), ID 1 corresponds to CSI report 1 corresponding to all P_{CSIRS} CSI-RS ports (for measurement), and ID 2 corresponds to CSI report 2 corresponding to a subset of (less than) P_{CSIRS} CSI-RS ports (for measurement). In one example, the subset of ports corresponds to

$$\frac{{P}_{CSIRS}}{k}$$

ports, where k can be a fixed integer (e.g. 2) or is configured or indicated via DCI.
In one example (duplex), ID 1 corresponds to CSI report 1 corresponding to a non-duplex (e.g. SBFD) operation, and ID 2 corresponds to CSI report 2 corresponding to a duplex (e.g. SBFD) operation.
In one example (CJT, NCJT, or DPS), ID 1 corresponds to CSI report 1 corresponding to a CJT transmission hypothesis, ID 2 corresponds to CSI report 2 corresponding to a NCJT transmission hypothesis, ID 3 corresponds to CSI report 3 corresponding to a DPS transmission hypothesis, and so on.

In one example, for multiple PGs (or O-RUs), i.e., for inter-PG or inter-O-RU case, ID 1 through ID X correspond to multiple hypotheses.
In one example (NES), ID 1 corresponds to CSI report 1 corresponding to all N_{g} PGs (for measurement), and ID 2 corresponds to CSI report 2 corresponding to a subset of (less than) N_{g} PGs (for measurement). In one example, the subset of PGs corresponds to

$$\frac{{N}_{g}}{k}$$

ports, where k can be a fixed integer (e.g. 2) or is configured or indicated via DCI.
In one example (duplex), ID 1 corresponds to CSI report 1 corresponding to x PGs for a non-duplex (e.g. SBFD) operation, and ID 2 corresponds to CSI report 2 corresponding to y PG a duplex (e.g. SBFD) operation where x>y. For example, x=2 and y=1.
In one example (CJT, NCJT, or DPS), ID 1 corresponds to CSI report 1 corresponding to a CJT transmission hypothesis across N_{g} PGs, ID 2 corresponds to CSI report 2 corresponding to a NCJT transmission hypothesis across N_{g} PGs, ID 3 corresponds to CSI report 3 corresponding to a DPS transmission hypothesis across N_{g} PGs, and so on.

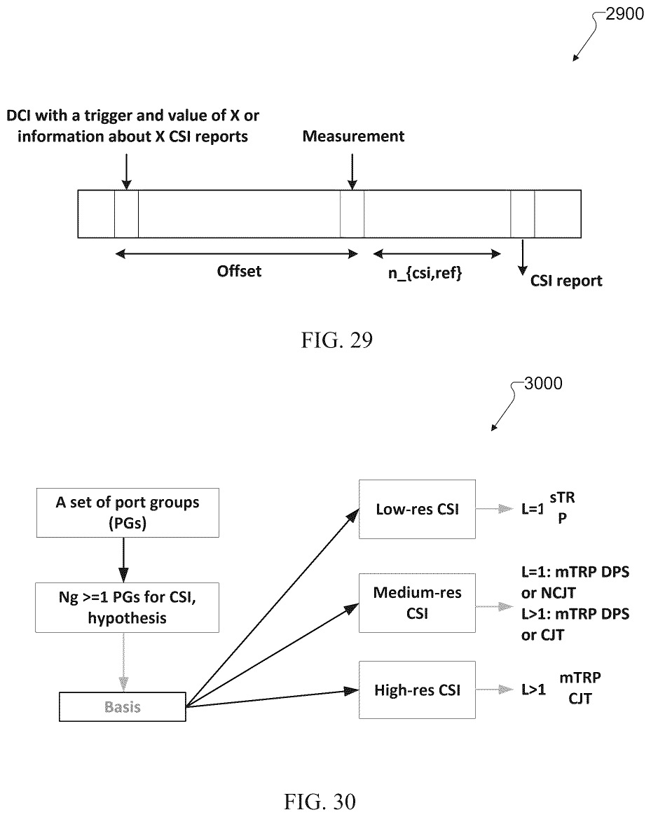

FIG. 29 illustrates a diagram of example CSI report IDs 2900 according to embodiments of the present disclosure. For example, the CSI report IDs 2900 may be utilized by a UE, such as, the UE 116 in FIG. 1. This example is for illustration only and other embodiments can be used without departing from the scope of the present disclosure.

In one example, as shown in FIG. 29, the UE receives a DCI (e.g. UL-DCI) with a CSI request field for code points associated with the list of CSI trigger states, the CSI request field triggers an AP CSI trigger state. Additionally, the DCI provides a value of X or an information about the set of IDs for CSI reports. As number of PGs (or O-RUs) or/and CSI hypotheses increases, the number of possible CSI reports also increases.

FIG. 30 illustrates a diagram of an example codebook 3000 according to embodiments of the present disclosure. For example, the codebook 3000 may be utilized by a UE, such as, the UE 116 in FIG. 1. This example is for illustration only and other embodiments can be used without departing from the scope of the present disclosure.

In embodiment, the UE is further configured with a codebook for PMI calculation and reporting, where the codebook includes at least two components; (a) basis and (b) coefficients, as shown in FIG. 30. The basis includes L vectors (or matrices) associated with SD (across SD units such as ports or/and PGs). Additionally, the basis can also include M vectors (or matrices) associated with FD (across FD units such as PRBs or SBs), or/and Q vectors (or matrices) associated with TD/DD (across TD/DD units such as time slots). The parameter (L, M, Q) can be fixed or configured (e.g. via higher layer parameter).

In one example, when L=1, the codebook corresponds to a low-resolution codebook based on a single vector, and when L>1, the codebook corresponds a high-resolution codebook based on a linear combination of multiple vectors.

When M is not provided/configured, there is no FD basis, i.e., there is no compression in FD, and hence the PMI component (i₂) for the co-phase or/and amplitude of the coefficients are reported for each SB in the CSI reporting band. When M is provided, there is FD compression across FD PRBs (cf. Rel-16 eType II codebook in 5G NR).

When Q is not provided/configured, there is no TD/DD basis, i.e., there is no compression in TD/DD. When Q is provided, there is TD/DD compression across TD/DD units or time slots (cf. Rel-18 eType II-Doppler codebook in 5G NR).

In one example, the basis vectors are DFT vectors. In one example, the basis vectors are orthogonal DFT vectors without oversampling or rotation factor (i.e. the DFT vectors are critically sampled, i.e. oversampling factor=1). In one example, the basis vectors are orthogonal DFT vectors with oversampling or rotation factor (i.e. the DFT vectors are oversampled with oversampling factor>1, e.g. 4). In one example, the SD basis vectors are orthogonal DFT vectors with oversampling or rotation factor=4. In one example, the FD or DD/TD basis vectors are orthogonal DFT vectors without oversampling or rotation factor.

In one example, when number of layers>1, precoder for each layer is calculated independently.

In one example, the structure of the precoding matric is given by summation over up to three basis vectors:

$$p = {\sum }_{i = 0}^{L - 1} {\sum }_{f = 0}^{M - 1} {\sum }_{d = 0}^{Q - 1} {B}_{i , f , d} \times {c}_{i , f , d} or [ \begin{matrix}{\sum }_{i = 0}^{L - 1} {\sum }_{f = 0}^{M - 1} {\sum }_{d = 0}^{Q - 1} {B}_{i , f , d} \times {c}_{i , f , d} \\ {\sum }_{i = 0}^{L - 1} {\sum }_{f = 0}^{M - 1} {\sum }_{d = 0}^{Q - 1} {B}_{i + L , f , d} \times {c}_{i + L , f , d}\end{matrix} ]$$

where B_{i,f,d} indicates a (i, f, d)-the element of the basis in three dimension, and c_{i,f,d} is the corresponding coefficient.

When there is no DD/TD compression, then

$$p = {\sum }_{i = 0}^{L - 1} {\sum }_{f = 0}^{M - 1} {B}_{i , f} \times {c}_{i , f}$$

or

$$[ \begin{matrix}{\sum }_{i = 0}^{L - 1} {\sum }_{f = 0}^{M - 1} {B}_{i , f} \times {c}_{i , f} \\ {\sum }_{i = 0}^{L - 1} {\sum }_{f = 0}^{M - 1} {B}_{i + L , f} \times {c}_{i + L , f}\end{matrix} ] .$$

When there is no FD compression, then

$$p = {\sum }_{i = 0}^{L - 1} {\sum }_{d = 0}^{Q - 1} {B}_{i , d} \times {c}_{i , d}$$

or

$$[ \begin{matrix}{\sum }_{i = 0}^{L - 1} {\sum }_{d = 0}^{Q - 1} {B}_{i , d} \times {c}_{i , d} \\ {\sum }_{i = 0}^{L - 1} {\sum }_{d = 0}^{Q - 1} {B}_{i + L , d} \times {c}_{i + L , , d}\end{matrix} ] .$$

When there is no FD and DD/TD compression, then

$$p = {\sum }_{i = 0}^{L - 1} {B}_{i} \times {c}_{i}$$

or

$$[ \begin{matrix}{\sum }_{i = 0}^{L - 1} {B}_{i} \times {c}_{i} \\ {\sum }_{i = 0}^{L - 1} {B}_{i + L} \times {c}_{i + L}\end{matrix} ] .$$

In one example, B_{i+L}=Bᵢ.

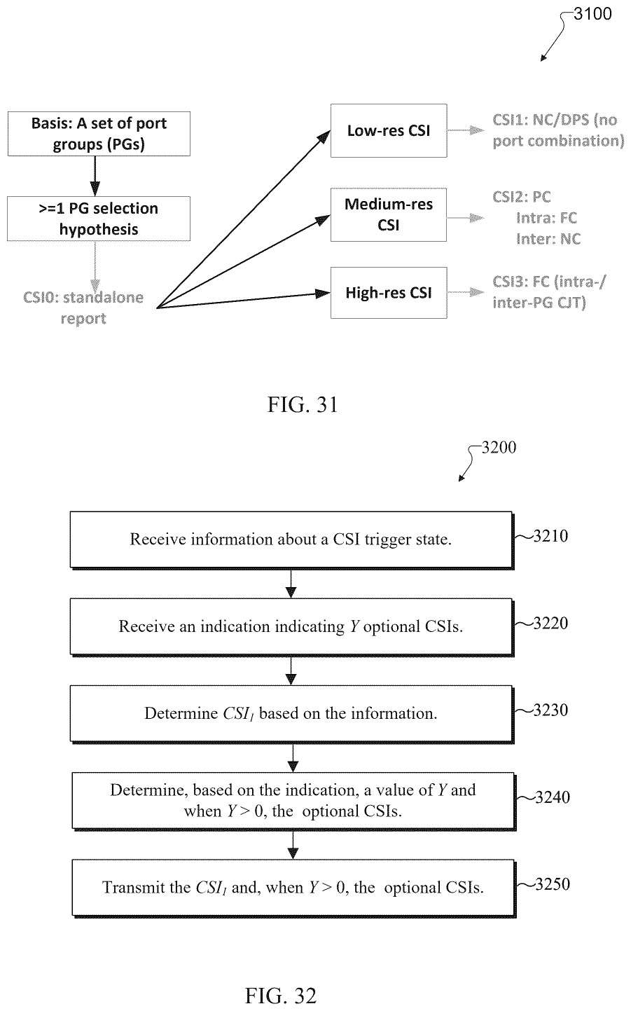

FIG. 31 illustrates a diagram of an example codebook 3100 according to embodiments of the present disclosure. For example, the codebook 3100 may be utilized by a UE, such as, the UE 116 in FIG. 1. This example is for illustration only and other embodiments can be used without departing from the scope of the present disclosure.

In one example, the SD basis corresponds to a set of ports or port groups (PG), and the UE is configured with a port or PG selection (CSI0 in FIG. 31), which can be a standalone report comprising >=1 PG selection hypotheses. Based on the hypotheses, the UE can be configured with a CSI report which is one of CSI1, CSI2, CSI3 based on hypothesis and coherency assumptions (inter-/intra).

FIG. 32 illustrates an example method 3200 performed by a UE in a wireless communication system according to embodiments of the present disclosure. The method 3200 of FIG. 32 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3200 is for illustration only and other embodiments can be used without departing from the scope of the present disclosure.

The method 3200 begins with the UE receiving information about a CSI trigger state (3210). For example, in 3210, the CSI trigger state includes information about CSI₁, and X-1 optional CSIs, CSI₂, . . . , CSI_{X}, where X≥1. In an example, the information includes an ID for the CSI₁, and X-1 IDs for the X-1 optional CSIs. In some examples, a value of X is predetermined or configured via higher layer.

The UE then receives an indication indicating Y optional CSIs (3220). For example, in 3220, when Y=0, the indication indicates none of the X-1 optional CSIs, and when Y>0, the indication indicates Y out of the X-1 optional CSIs. In some examples, the indication corresponds to a bit sequence, b₂ . . . b_{X}, where a value bᵢ=0 signifies that CSIᵢ is not indicated and a value bᵢ=1 signifies that CSIᵢ is indicated. In various embodiments, the indication is via DCI, the DCI is a two-stage DCI comprising a first stage indicating a value of Y, and when Y>0, the DCI includes a second stage indicating the Y optional CSIs.

The UE then determines CSIᵢ based on the information (3230). In various embodiments, a CSI from the CSI₁ and X-1 optional CSIs is associated with an ID, at least one port or PG for channel measurement, and a report quantity indicating a content of the CSI. In various embodiments, the CSI is associated with at least one of at least one port or PG for interference measurement, a codebook when a PMI is included in the content of the CSI, a table when a CQI is included in the content of the CSI, a frequency granularity of the PMI or CQI, and a slot offset for determining a slot for measurement and a slot for transmitting the CSI₁, and when Y>0, the Y optional CSIs.

The UE then determines, based on the indication, a value of Y and, when Y>0, the Y optional CSIs (3240). The UE then transmits the CSI₁ and, when Y>0, the Y optional CSIs (3250).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to:
receive information about a channel state information (CSI) trigger state, the CSI trigger state including information about CSI₁, and X-1 optional CSIs, CSI₂, . . . , CSI_{X}, where X≥1, and
receive an indication indicating Y optional CSIs, wherein:
when Y=0, the indication indicates none of the X-1 optional CSIs, and
when Y>0, the indication indicates Y out of the X-1 optional CSIs; and
a processor operably coupled to the transceiver, the processor configured to:
determine the CSI₁ based on the information, and
determine, based on the indication, (i) a value of Y and (ii) when Y>0, the Y optional CSIs,
wherein the transceiver is further configured to transmit (i) the CSI₁ and (ii) when Y>0, the Y optional CSIs.

2. The UE of claim 1, wherein the information includes an identifier (ID) for the CSI₁, and X-1 IDs for the X-1 optional CSIs.

3. The UE of claim 1, wherein the indication corresponds to a bit sequence, b₂ . . . b_{X}, where a value bᵢ=0 signifies that CSIᵢ is not indicated and a value bᵢ=1 signifies that CSIᵢ is indicated.

4. The UE of claim 1, wherein a value of X is predetermined or configured via higher layer.

5. The UE of claim 1, wherein:
the indication is via downlink control information (DCI),
the DCI is a two-stage DCI comprising a first stage indicating a value of Y, and
when Y>0, the DCI includes a second stage indicating the Y optional CSIs.

6. The UE of claim 1, wherein a CSI from the CSI₁ and X-1 optional CSIs is associated with an identifier (ID), at least one port or port group (PG) for channel measurement, and a report quantity indicating a content of the CSI.

7. The UE of claim 6, wherein the CSI is associated with at least one of:
at least one port or PG for interference measurement,
a codebook when a precoding matrix indicator (PMI) is included in the content of the CSI,
a table when a channel quality indicator (CQI) is included in the content of the CSI,
a frequency granularity of the PMI or CQI, and
a slot offset for determining a slot for measurement and a slot for transmitting the CSI₁, and when Y>0, the Y optional CSIs.

8. A base station (BS) comprising:
a processor; and
a transceiver operably coupled to the processor, the transceiver configured to:
transmit information about a channel state information (CSI) trigger state, the CSI trigger state including information about CSI₁, and X-1 optional CSIs, CSI₂, . . . , CSI_{X}, where X≥1;
transmit an indication indicating Y optional CSIs, wherein:
when Y=0, the indication indicates none of the X-1 optional CSIs, and
when Y>0, the indication indicates Y out of the X-1 optional CSIs; and
receive (i) the CSI₁ and (ii) when Y>0, the Y optional CSIs.

9. The BS of claim 8, wherein the information includes an identifier (ID) for the CSI₁, and X-1 IDs for the X-1 optional CSIs.

10. The BS of claim 8, wherein the indication corresponds to a bit sequence, b₂ . . . b_{X}, where a value bᵢ=0 signifies that CSIᵢ is not indicated and a value bᵢ=1 signifies that CSIᵢ is indicated.

11. The BS of claim 8, wherein a value of X is predetermined or configured via higher layer.

12. The BS of claim 8, wherein:
the indication is via downlink control information (DCI),
the DCI is a two-stage DCI comprising a first stage indicating a value of Y, and
when Y>0, the DCI includes a second stage indicating the Y optional CSIs.

13. The BS of claim 8, wherein a CSI from the CSI₁ and X-1 optional CSIs is associated with an identifier (ID), at least one port or port group (PG) for channel measurement, and a report quantity indicating a content of the CSI.

14. The BS of claim 13, wherein the CSI is associated with at least one of:
at least one port or PG for interference measurement,
a codebook when a precoding matrix indicator (PMI) is included in the content of the CSI,
a table when a channel quality indicator (CQI) is included in the content of the CSI,
a frequency granularity of the PMI or CQI, and
a slot offset for determining a slot for measurement and a slot for transmitting the CSI₁, and when Y>0, the Y optional CSIs.

15. A method performed by a user equipment (UE), the method comprising:
receiving information about a channel state information (CSI) trigger state, the CSI trigger state including information about CSI₁, and X-1 optional CSIs, CSI₂, . . . , CSI_{X}, where X≥1;
receiving an indication indicating Y optional CSIs, wherein:
when Y=0, the indication indicates none of the X-1 optional CSIs, and
when Y>0, the indication indicates Y out of the X-1 optional CSIs;
determining the CSI₁ based on the information;
determining, based on the indication, (i) a value of Y and (ii) when Y>0, the Y optional CSIs; and
transmitting (i) the CSI₁ and (ii) when Y>0, the Y optional CSIs.

16. The method of claim 15, wherein the information includes an identifier (ID) for the CSI₁, and X-1 IDs for the X-1 optional CSIs.

17. The method of claim 15, wherein the indication corresponds to a bit sequence, b₂ . . . b_{X}, where a value bᵢ=0 signifies that CSIᵢ is not indicated and a value bᵢ=1 signifies that CSIᵢ is indicated.

18. The method of claim 15, wherein a value of X is predetermined or configured via higher layer.

19. The method of claim 15, wherein:
the indication is via downlink control information (DCI),
the DCI is a two-stage DCI comprising a first stage indicating a value of Y, and
when Y>0, the DCI includes a second stage indicating the Y optional CSIs.

20. The method of claim 15, wherein a CSI from the CSI₁ and X-1 optional CSIs is associated with an identifier (ID), at least one port or port group (PG) for channel measurement, and a report quantity indicating a content of the CSI.
